(19) United States
(12) Patent Application Publication
(10) Pub. No.: US 2007/0196412 A1
(43) Pub. Date: Aug. 23, 2007

(54) Composition for the impregnation of fibers, fabrics and nettings imparting a protective activity against pests

(75) Inventors: Ulrich Karl, Grunstadt (DE); Heinz Heissler, Frankenthal (DE); John H. Thomas, Bridgewater, NJ (US); Holger Schopke, Neckargemund (DE); Joachim Burger, Neupotz (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 10/596,677

(22) PCT Filed: Dec. 21, 2004
(86) PCT No.: PCT/EP04/14536

§ 371 Date: Jun. 21, 2006

Related U.S. Application Data
(63) Continuation-in-part of application No. 10/740,428, filed on Dec. 22, 2003.

(51) Int. Cl. A01N 25/34

(52) U.S. Cl. 424/411; 427/427.4; 427/428.01; 514/506; 977/773

(57) ABSTRACT

Insecticide composition for application to a textile material or plastics material selected from the group consisting of yarn, fibers, fabric, knitgoods, nonwovens, netting material, foils, tarpaulins and coating compositions, which insecticide composition comprises a mixture including at least one insecticide and/or at least one repellent, and at least one binder; an impregnated textile material or plastics material comprising at least one insecticide and/or at least one repellent, and at least one binder; processes for impregnation of a textile material or plastics material and a process for coating of a textile material or plastics material.

The present invention relates to an insecticide composition for application to a textile material or plastics material selected from the group consisting of yam, fibers, fabric, knitgoods, nonwovens, netting material, foils, tarpaulins and coating compositions, which insecticide composition comprises a mixture including at least one insecticide and/or at least one repellent, and at least one binder; an impregnated textile material or plastics material comprising at least one insecticide and/or at least one repellent, and at least one binder; processes for impregnation of a textile material or plastics material and a process for coating of a textile material or plastics material.

Infectious diseases cause huge damages by debilitating or even killing humans and animals in many countries, especially in tropical countries. Many of these diseases (e.g. malaria, dengue and yellow fever, lymphatic filariasis, and leishmaniasis) are transmitted by insects. Since many medical methods like vaccination or medical treatments are either impossible or too expensive or have been rendered ineffective due to spreading resistance against drugs, efforts have been concentrated on controlling the transmitting insects. Methods to control these insects comprise treating surfaces of huts and houses, air spraying and impregnation of curtains and bednets. The latter treatment is up to now mostly done by dipping the textile material into emulsions or dispersions of insecticides or spraying them onto the nets. Since this provides only a loose adhesion of the insecticide molecules on the surface of the fibers, this treatment is not wash-permanent and has to be repeated after each washing. Studies have proven long-lasting insecticide-treated nets (LLINs) to be more reliable in preventing carrier-bome diseases in comparison with conventional nets, which have to be re-impregnated with insecticide after each washing. Experience shows, however, that washed nets are not re-treated in many cases leaving them without any biological activity. WHO, UNICEF and global relief organisations therefore recommend pre-treated, long-lasting insecticide-treated nets which are wash-permanent as an effective means for the containment of deadly tropical diseases, especially malaria and dengue fever. This is not only comfortable for the user but gives him an economic advantage as well, saving the costs for the repeated impregnation. It is an ecological advantage as well, since the permanent treatment is done under controlled conditions in textile finishing plants.

WO 01/37662 discloses impregnated nettings or fabrics for insect or tick killing and/or repellent of an insect or tick comprising an insecticide and/or a repellent, and a film forming component reducing the wash off and degradation of the insecticide component from the netting or fabric by forming a water- and optionally an oil-resistant film. The film forming component preferably comprises one or more components selected from paraffin oil or wax derivatives, silicon derivatives, silicon oils or wax derivatives, and polyfluorocarbon derivatives. The netting or fabric is impregnated by adding a solution or a water emulsion of an insecticide and/or repellent and a film forming component successively (in two steps) or in one process step. According to the specification of WO 01/37662 is the insecticide and/or repellent dissolved in an organic solvent in the process for impregnation of a fabric or a netting.

WO 03/034823 discloses an insecticide composition for application to a fabric material, which composition comprises a mixture including an insecticide, a copolymeric binder, that, after drying and while the fabric material is dry, imparts hydrophobicity to the insecticide, and a dispersing agent, that, after application of the composition to a fabric and upon wetting the fabric, reduces the hydrophobicity imparted to the insecticide by the binder to permit limited insecticide release. The copolymeric binder is prepared as a copolymer emulsion that is derived by an emulsion polymerization technique from monomers selected from at least one of the groups including a) vinyl esters of aliphatic acid having 1 to 18 carbon atoms, such as vinyl acetate and vinyl versatate; b) acrylic and methacrylic esters of an alcohol having 1 to 18 carbon atoms, such as butyl acrylate, 2-ethylhexylacrylate, and methyl acrylate; and c) mono- and di-ethylenically unsaturated hydrocarbons, such as styrene, and aliphatic diens, such as butadiene. The preferred copolymeric binder is prepared by emulsion polymerisation of two different monomers. The insecticide composition of WO 03/034823 is applied to the fabric or netting by dipping, spraying, brushing, and the like. According to the examples the insecticides have to be dissolved in organic solvents before applying the insecticide composition to a fabric material.

U.S. Pat. No. 5,631,072 discloses the manufacture of fabric intended to be made into washable garments, more specifically to the placement of an insecticide such as permethrin in the fabric by impregnation with polymeric binders and a cross-linking agent, or by surface coating with a polymeric binder and a thickening agent to improve the efficiency as an insect repellent and retention of the permethrin in the fabric as an effective insecticide through successive washings of the garments. According to the examples, suitable binders are acrylic binders and polyvinylacetate binders, which are not further specified. The amount of insecticide in the solutions for impregnation of the fabric is very high (1250 mg insecticide per m²).

It is an object of the present invention to provide an insecticide composition for application to a textile material or plastics material, wherein the insecticide is not washed out and in which the bioavailability of the insecticide for killing insects is maintained after multiple washes.

According to the present invention there is provided an insecticide composition for application to a textile material or plastics material which composition comprises a mixture including
a) at least one insecticide and/or at least one repellent as component A, and
   b1) at least one acrylic binder as component B1 obtainable by emulsion polymerisation of the following components:
      b1a) n-butyl acrylate as component B1A,
      b1b) at least one monomer of formula I as component B1B 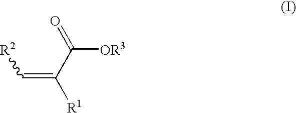
         wherein
         R¹, R² and R³ are independently selected from C₁- to C₁₀-alkyl which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, secbutyl, tert-butyl; substituted or unsubstituted aryl, preferably substituted or unsubstituted C₆- to C₁₀-aryl, more preferably substituted or unsubstituted C₆-aryl, for example phenyl or tolyl;
         R¹ and R² may further be H;
         except of R³=n-butyl, when R¹ and R² are H.
         Preferably R¹ is H or methyl; R² is preferably H; R³ is preferably methyl, ethyl or 2-ethylhexyl.
         More preferably R¹ is H or methyl, R² is H and R³ is methyl, ethyl or 2-ethylhexyl.
         Most preferably the monomer of formula I is selected from the group consisting of 2-ethylhexylacrylate, methylacrylate, methylmethacrylate and ethylacrylate.
      b1c) at least one monomer of formula II as component B1C 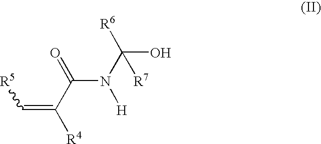
         wherein
         R⁴, R⁵, R⁶ and R⁷ are independently selected from the group consisting of H, C₁- to C₁₀-alkyl which may be linear or branched, for example, methyl, ethyl, n-propyl, i-propyl, n-butyl, i-butyl, sec-butyl, tertbutyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R⁴, R⁵, R⁶ and R⁷ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
         more preferably R⁴ is H or methyl, R⁵, R⁶ and R⁷ are preferably independent of each other H;
         most preferably R⁴ is H or methyl and R⁵, R⁶ and R⁷ are H;
      b1d) optionally at least one momomer of formula III as component B1D 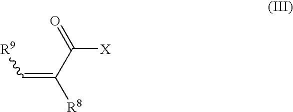
         wherein
         R⁸ and R⁹ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl;
         preferably R⁸ and R⁹ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
         most preferably R⁸ and R⁹ are H;
         X is selected from the group consisting of H, OH, NH₂, OR¹¹OH, glycidyl, hydroxypropyl, 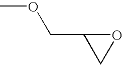
         groups of the formula 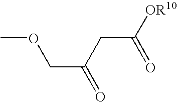
         wherein
         R¹⁰ is selected from the group consisting of C₁- to C₁₀-alkyl which may be branched or linear, for example rnethyl, ethyl, n-propyl, i-propyl, n-butyl, i-butyl, sec-butyl, tert-butyl, n-pentyl, i-pentyl, sec-pentyl, neopentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
         R¹¹ is selected from the group consisting of C₁- to C₁₀-alkylene, for example methylene, ethylene, propylene, butylene, pentylene, hexy-lene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene; most preferably X is acetoacetyl;
      b1e) further monomers which are copolymerizable with the monomers mentioned above selected from
         b1e1) polar monomers, preferably (meth)acrylic nitrile and/or methyl(meth)acrylate as component B1E1; and/or
         b1e2) non polar monomers, preferably styrene and/or amethylstyrene as component B1E2;
   and/or
   b2) at least one polyurethane as component B2, obtainable by reaction of the following components:
      b2a) at least one diisocyanate or polylisocyanate as component B2A, preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
      b2b) at least one diol, triol or polyol as component B2B, preferably aliphatic, cycloaliphatic and/or araliphatic diols having 2 to 14, preferably 4 to 10 carbon atoms, more preferably 1,6-hexanediol or neopentyl glycol;
      b2c) optionally further components as component B2C, preferably adipic acid or carbonyl diimidazole (CDI); and
      b2d) optionally further additives as component B2D.

The insecticide composition of the present invention may be in form of a solid or an aqueous formulation, wherein the aqueous formulation is preferred.

The insecticide composition of the present application provides wash resistance while permitting continuous release of the insecticide and/or repellent at a controlled rate, in order to provide the required bioavailability of the insecticide and/or repellent. It was found by the inventors that insecticide compositions comprising components A as well as B1A, B1B and B1C and/or B2 provide a very good wash resistance while permitting a continuous release of the insecticide and/or repellent at a controlled rate. Further, the insecticide emission to the environment is decreased by using the composition of the present invention which is applied to a textile material or plastics material.

In the context of the present invention a textile material or plastics material is a material selected from the group consisting of yam, fibers, fabric, knitgoods, nonwovens, netting material, foils, tarpaulins and coating compositions. The netting material may be prepared by any method known in the art, for example by circular knitting or warp knitting, or by sewing parts of a netting to obtain the desired nettings.

The insecticide composition of the present invention comprises in general 0.001 to 95% by weight preferably 0.1 to 45% by weight, more preferably 0.5 to 30% by weight, based on the weight of the insecticide composition, of at least one insecticide and/or repellent.

The insecticide composition preferably comprises the following components, based on the solids content of the composition
a) 0.1 to 45% by weight, preferably 0.5 to 30% by weight, more preferably 1 to 25% by weight of at least one insecticide and/or at least one repellent (component A), and
   b1) 55 to 99% by weight, preferably 70 to 98% by weight, more preferably 75 to 90 by weight of at least one acrylic binder (component B1) as defined above, comprising;
      b1a) 10 to 90% by weight, preferably 15 to 80% by weight, more preferably 20 to 70% by weight based on the acrylic binder of n-butyl acrylate (component B1A);
      b1b) 10 to 90% by weight, preferably 12 to 85% by weight, more preferably 15 to 65% by weight based on the acrylic binder of at least one monomer of formula I (component B1B);
      b1c) 1 to 5% by weight based on the acrylic binder of at least one monomer of formula II (component B1C);
      b1d) 0 to 5% by weight, preferably 1 to 4% by weight, more preferably 0.2 to 3% by weight based on the acrylic binder of at least one monomer of formula III (component B1D);
      b1e) further monomers which are copolymerizable with the monomers mentioned (component B1E) above selected from
         b1e1) 0 to 30% by weight, preferably 0 to 25% by weight, more preferably 5 to 20% by weight based on the acrylic binder of at least one polar momomer, preferably (meth)acrylic nitrile and/or methyl(meth)acrylate (component B1E1); and/or
         b1e2) 0 to 40% by weight, preferably 0 to 30% by weight, more preferably 5 to 20% by weight based on the acrylic binder of at least one non polar momomer, preferably styrene and/or amethylstyrene (component B1E1);
and/or
   b2) 55 to 99% by weight, preferably 70 to 98% by weight, more preferably 75 to 90 by weight of at least one polyurethane (component B2) as defined above, comprising:
      b2a) 55 to 99% by weight, preferably 70 to 98% by weight, more preferably 75 to 90 by weight based on the polyurethane of at least one diisocyanate or polyisocyanate (component B2A), preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
      b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably 1,6-hexanediol or neopentyl glycol;
      b2c) 0 to 10% by weight, preferably 0.1 to 5% by weight, more preferably 1 to 5% by weight based on the polyurethane of further components (component B2C), preferably adipic acid or carbonyl diimidazole (CDI); and
      b2d) 0 to 10% by weight, preferably 0.1 to 5% by weight, more preferably 0.5 to 5% by weight based on the polyurethane of further additives (component B2D)
         wherein the sum of the components is 100% by weight of solids content of the insecticide composition.

In a further preferred embodiment the insecticide composition comprises the following components, based on the solids content of the composition
a) 20 to 70% by weight, preferably 25 to 65% by weight, more preferably 30 to 65% by weight of at least one insecticide and/or at least one repellent (component A), and
   b1) 30 to 80% by weight, preferably 35 to 75% by weight, more preferably 35 to 70 by weight of at least one acrylic binder (component B1) as defined above, comprising;
      b1a) 10 to 90% by weight, preferably 15 to 85% by weight, more preferably 30 to 85% by weight based on the acrylic binder of n-butyl acrylate (component B1A);
      b1b) 10 to 90% by weight, preferably 12 to 85% by weight, more preferably 15 to 65% by weight based on the acrylic binder of at least one monomer of formula I (component B1B);
      b1c) 1 to 5% by weight based on the acrylic binder of at least one monomer of formula II (component B1C);
      b1d) 0 to 5% by weight, preferably 0.1 to 4% by weight, more preferably 0.2 to 3% by weight based on the acrylic binder of at least one monomer of formula III (component B1D);
      b1e) further monomers which are copolymerizable with the monomers mentioned (component B1E) above selected from
         b1e1) 0 to 30% by weight, preferably 0 to 25% by weight, more preferably 5 to 20% by weight based on the acrylic binder of at least one polar momomer, preferably (meth)acrylic nitrile and/or methyl(meth)acrylate (component B1E1); and/or
         b1e2) 0 to 40% by weight, preferably 0 to 30% by weight, more preferably 5 to 20% by weight based on the acrylic binder of at least one non polar momomer, preferably styrene and/or amethylstyrene (component B1E1);
and/or
   b2) 30 to 80% by weight, preferably 35 to 75% by weight, more preferably 35 to 70 by weight of at least one polyurethane (component B2) as defined above, comprising:
      b2a) 55 to 99% by weight, preferably 70 to 98% by weight, more preferably 75 to 90 by weight based on the polyurethane of at least one diisocyanate or polyisocyanate (component B2A), preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
      b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably 1,6-hexanediol or neopentyl glycol;
      b2c) 0 to 10% by weight, preferably 0.1 to 5% by weight, more preferably 1 to 5% by weight based on the polyurethane of further components (component B2C), preferably adipic acid or carbonyl diimidazole (CDI); and
      b2d) 0 to 10% by weight, preferably 0.1 to 5% by weight, more preferably 0.5 to 5% by weight based on the polyurethane of further additives (component B2D)
         wherein the sum of the components is 100% by weight of solids content of the insecticide composition.

The aim of the invention is to control a variety of pests, such as ticks, cockroaches, bed bugs, mites, fleas, lice, leeches, houseflies, mosquitoes, termites, ants, moths, spiders, grasshoppers, crickets, silverfish, also in form of their larvae and eggs, and other flying and crawling insects, and molluscs, e.g. snails and slugs, and rodents, eg. rats and mice as well as fungi, e.g. fungi causing athlete's foot.

The textile material or plastics material may be made form a variety of natural and synthetic fibers, also as textile blends in woven or non-woven form, as knit goods, yarns or fibers. Natural fibers are for example cotton, wool, silk, jute or hamp. Synthetic fibers are for example polyamides, polyesters, polyacryl nitrites, polyolefines, for example polypropylene or polyethylene, Teflon, and mixtures of fibers, for example mixtures of synthetic and natural fibers. Polyamides, polyolefins and polyesters are preferred. Polyethylene terephthalate is especially preferred.

According to the present invention the term textile material or plastics material also discloses non-textile substrates such as coating compositions, leather, synthetic adaptions of leather, flocked fabrics, sheetings, foils and packaging material.

Most preferred are nettings made from polyester, especially polyethylene terephthalate.

The textile material or plastics material may be in form of coverings, for example bedclothes, mattresses, pillows, duvets, cushions, curtains, wall coverings, carpeting and window, cupboard and door screens. Further typical textile materials or plastics materials are geotextiles, tents, inner soles of shoes, garments, such as socks, trousers, shirts, i.e. preferably garments, e.g. uniforms, used in body areas exposed to insecticide bites and the like as well as horse blankets. The nettings are for example used as bed nets for example mosquito nets, or for covering or as nets in agriculture and viniculture. Other applications are movable fences for the protection of humans and animals against air-borne low-flying insects. Fabrics or nettings may be used for packages, wrapping sacks, containers for food, seeds and feed thus protecting the material from attack by insects but avoiding direct contact with the insecticide-treated nets or fabrics.

Treated foils or tarpaulins can be used on all human premises which are permanently or temporarily inhabited such as refugee camps.

It is further possible to use the treated nettings in dwellings having mud walls. A treated netting is pressed into a fresh, wet wall mud before it dries. The mud will ooze into the holes in the net but the yarn of the net will not be covered. When this wall covering is dried the insecticide and/or repellent of the treated net is slowly released and can repell or kill pests that come into contact with the wall.

The insecticide composition of the present invention is particularly suitable for application to polyester nettings as used for mosquito nets.

The insecticide composition of the present invention may be applied to textile materials or plastics materials before their formation into the desired products, i.e. while still a yarn or in sheet form, or after formation of the desired products.

Insecticide and/or Repellent (Component A)

According to the present invention the term insecticide and/or repellent also discloses besides insecticides and repellents rodenticides, fungicides, molluscicides, larvicides and ovicides.

Preferably, the insecticide and/or repellent is an insecticide and/or repellent with a fast paralyzing or killing effect of the insect and very low mammalian toxicity. Suitable insecticides and/or repellents are known by a person skilled in the art. Suitable insecticides and repellents and suitable dosages are for example mentioned on the webside of the World Health Organization (http://www.who.int/whopes/recommendations/en/), especially in “Malaria Vector Control”, “Insecticides for Indoor Residual Spraying” by Dr. J. A. Najera & Dr. M. Zaim, 2001.

Preferred insecticides and/or repellents are mentioned below:

pyrethroid compounds such as
Etofenprox: 2-(4-ethoxyphenyl)-2-methylpropyl-3-phenoxybenzyl ether,
Chlorfenapyr: 4-bromo-2-(4-chlorophenyl)-1-ethoxymethyl-5-(trifluoromethyl)pyrrole-3-carbonitrile,
Fenvalerate: (RS)-alpha-cyano-3-phenoxybenzyl (RS)-2-(4-chlorophenyl)-3 methylbutyrate,
Esfenvalerate: (S)-alpha-cyano-3-phenoxybenzyl (S)-2-(4-chlorophenyl)-3-methylbutyrate,
Fenpropathrin: (RS)-alpha-cyano-3-phenoxybenzyl 2,2,3,3-tetramethylcyclopropanecarboxylate,
Cypermethrin: (RS)-alpha-cyano-3-phenoxybenzyl (1RS)-cis, trans-3-(2,2-dichlorovinyl)-2,2-dimethylcyclopropanecarboxylate,
alpha-Cypermethrin: racemate comprising the (S)-α-(1R) and (R)-α-(1S) diastereomers,
Permethrin: 3-phenoxybenzyl (1RS)-cis, trans-3-(2,2-dichlorovinyl)-2,2-dimethylcyclopropanecarboxylate,
Cyhalothrin: (RS)-alpha-cyano-3-phenoxybenzyl (Z)-(1RS)-cis-3-(2-chloro-3,3,3-trifluoroprop-1-enyl)-2,2-dimethylcyclopro panecarboxylate, lambda-cyhalothrin,
Deltamethrin: (S)-alpha-cyano-3-phenoxybenzyl (1R)-cis-3-(2,2-dibromovinyl)-2,2-dimethylcyclopropanecarboxylate,
Cycloprothrin: (RS)-alpha-cyano-3-phenoxybenzyl (RS)-2,2-dichloro-1 -(4-ethoxyphenyl)cyclopropanecarboxylate,
Fluvalinate: alpha-cyano-3-phenoxybenzyl N-(2-chloro-alpha, alpha, alpha, alpha-trifluoro-p-tolyl)-D-valinate,
Bifenthrin: (2-methylbiphenyl-3-ylmethyl)0(Z)-(1RS)-cis-3-(2-chloro-3,3,3-trifluoro-1-propenyl)-2,2-dimethylcyclopropanecarboxylate, 2-methyl-2-(4-bromodifluoromethoxyphenyl)propyl (3-phenoxybenzyl)ether,
Tralomethrin: (S)-alpha-cyano-3-phenoxybenzyl (1R-cis)3((1′RS)(1′,2′,2′,2′-tetrabromoethyl))-2,2-dimethylcyclopropanecarboxylate,
Silafluofen: 4-ethoxyphenyl(3-(4-fluoro-3-phenoxyphenyl)propyl}dimethylsilane,
D-fenothrin: 3-phenoxybenzyl (1R)-cis, trans)-chrysanthemate,
Cyphenothrin: (RS)-alpha-cyano-3-phenoxybenzyl (1R-cis, trans)-chrysanthemate, D-resmethrin: 5-benzyl-3-furylmethyl (1R-cis, trans)-chrysanthemate,
Acrinathrin: (S)-alpha-cyano-3-phenoxybenzyl (1R-cis(Z))-(2,2-dimethyl-3-(oxo-3-(1,1,1,3,3,3-hexafluoropropyloxy)propenyl(cyclopropanecarboxylate,
Cyfluthrin: (RS)-alpha-cyano-4-fluoro-3-phenoxybenzyl 3-(2,2-dichlorovinyl)-2,2-dimethylcyclopropanecarboxylate,
Tefluthrin: 2,3,5,6-tetrafluoro-4-methylbenzyl (1RS-cis (Z))-3-(2-chloro-3,3,3-trifluoro-prop-1-enyl)-2,2-dimethylcyclopropanecarboxylate,
Transfluthrin: 2,3,5,6-tetrafluorobenzyl (1R-trans)-3-(2,2-dichlorovinyl)-2,2-dimethyl-cyclopropanecarboxylate,
Tetramethrin: 3,4,5,6-tetrahydrophthalimidomethyl (1RS)-cis, trans-chrysanthemate,
Allethrin: (RS)-3-allyl-2-methyl-4-oxocyclopent-2-enyl (1RS)-cis, trans-chrysanthemate,
Prallethrin: (S)-2-methyl-4-oxo-3-(2-propynyl)cyclopent-2-enyl (1R)-cis, trans-chrysanthemate,
Empenthrin: (RS)-1-ethynyl-2-methyl-2-pentenyl (1R)-cis,trans-chrysanthemate,
Imiprothrin: 2,5-dioxo-3-(prop-2-ynyl)imidazolidin-1-ylmethyl (1 R)-cis, trans-2,2-dimethyl-3-(2-methyl-1-propenyl)-cyclopropanecarboxylate,
D-flamethrin: 5-(2-propynyl)-furfuryl (1R)-cis, trans-chrysanthemate, and 5-(2-propynyl)furfuryl 2,2,3,3-tetramethylcyclopropanecarboxylate;
Pyriproxyfen: 4-phenoxyphenyl (RS)-2-(2-pyridyloxy)propyl ether;
pyrethrum;
d-d, trans-cyphenothrin: (RS)-α-cyano-3-phenoxybenzyl (1RS,3RS;1RS,3SR)-2,2-dimethyl-3-(2-methylprop-1-enyl)cyclopropanecarboxylate;
DDT;

Carbamate compounds such as
Alanycarb: S-methyl-N[[N-methyl-N-[N-benzyl-N(2-ethoxy-carbonylethyl)amino-thio]carbamoyl]thioacetimidate,
Bendiocarb: 2,2-dimethyl-1,3-benzodioxol-4-yl-methylcarbamate), Carbaryl(1-naphthyl N-methylcarbamate,
Isoprocarb: 2-(1-methylethyl)phenyl methylcarbamate,
Carbosulfan: 2,3 dihydro-2,2-dimethyl-7-benzofuranyl[(dibutylamino)thio]methylcarbamate,
Fenoxycarb: Ethyl[2-(4-phenoxyphenoxy)ethyl]carbamate,
Indoxacarb: Methyl-7-chloro22,3,4°,5-tetrahydro-2-[methoxycarbonyl (-4-trifluoromethoxyphenyl)]
Propoxur: 2-isopropyloxyphenol methylcarbamate,
Pirimicarb: 2-dimethylamino-5,6-dimethyl-4-pyrimidinyl-dimethylcarbamate,
Thiodiocarb: Dimethyl N,N′(thiobis((methylimino)carbonoyloxy)bisethanimidiothioate).
Methomyl: S-methyl N-((methylcarbamoyl)oxy)thioacetamidate,
Ethiofencarb: 2-((ethylthio)methyl)phenyl methylcarbamate,
Fenothiocarb: S-(4-phenoxybutyl)-N,N-dimethyl thiocarbamate,
Cartap: S,S′-(2-5 dimethylamino)trimethylene)bis (thiocarbamate)hydrochloride,
Fenobucarb: 2-sec-butylphenylmethyl carbamate,
XMC: 3,5-dimethylphenyl-methyl carbamate,
Xylylcarb: 3,4-dimethylphenylmethylcarbamate;

organophosphorous compounds such as
Trichlorfon: Phosphoric acid, (2,2,2-trichloro-1-hydroxyethyl)-, dimethyl ester
Fenitrothion: O,O-dimethyl O-(4-nitro-m-tolyl)phosphorothioate,
Diazinon: O,O-diethyl-O-(2-isopropyl-6-methyl-4-pyrimidinyl)phosphorothioate,
Pyridaphenthion: O-(1,6-dihydro-6-oxo-1-phenylpyrazidin-3-yl) O,O-diethyl phosphorothioate,
Pirimiphos-Etyl: O,O-diethyl O-(2-(diethylamino)6-methyl-pyrimidinyl)phosphorothioate,
Pirimiphos-Methyl: O-[2-(diethylamino)-6-methyl-4 pyrimidinyl] O,O-dimethyl phosphorothioate,
Etrimphos: O-6-ethoxy-2-ethyl-pyrimidin-4-yl-O,O-dimethyl-phosphorothioate,
Fenthion: O,O-dimethyl-O-[-3-methyl-4-(methylthio)phenyl phosphorothioate,
Phoxim: 2-(diethoxyphosphinothoyloxyimino)-2-phenylacetonitrile,
Chlorpyrifos: O,O-diethyl-O-(3,5,6-trichloro-2-pyrinyl)phosphorothioate,
Chlorpyriphosmethyl: O,O-dimethyl O-(3,5,6-trichloro-2-pyridinyl)phosphorothioate,
Cyanophos: O,O-dimethyl O-(4 cyanophenyl)phosphorothioate,
Pyraclofos: (R,S)[4-chlorophenyl)-pyrazol-4-yl]-O-ethyl-S-n-propyl phosphorothioate,
Acephate: O, S-dimethyl acetylphosphoroamidothioate,
Azamethiphos: S-(6-chloro-2,3-dihydro-oxo-1,3-oxazolo[4,5-b]pyridine-3-ylmethyl phosphorothioate,
Malathion: O,O-dimethyl phosphorodithioate ester of diethyl mercaptosuccinate,
Temephos: (O,O′(thiodi-4-1-phenylene) O,O,O,O-tetramethyl phosphorodithioate,
Dimethoate: ((O,O-dimethyl S-(n-methylcarbamoylethyl)phosphorodithioate,
Formothion: S[2-formylmethylamino]-2-oxoethyl]-O,O-dimethyl phosphorodithioate,
Phenthoate: O,O-dimethyl S-(alpha-ethoxycarbonylbenzal)-phosphorodithioate;
Iodofenphos: O-(2,5-dichloro-4-iodophenyl)-O,O-dimethyl-phosphorthioate.

Insecticides with a sterilising effect on adult mosquitoes such as
1-(alfa-(chloro-alpha-cyclopropylbenzylidenamino-oxy)-p-tolyl)-3-(2,6-difluorobenzoyl)urea,
Diflubenzuron: N-(((3,5-dichloro-4-(1,1,2,2-tetraflouroethoxy)phenylamino)carbonyl)2,6 difluoro benzamid,
Triflumuron: 2-Chloro-N-(((4-(trifluoromethoxy)phenyl)-amino-)carbonyi)benzamide, or a triazin such as N-cyclopropyl-1,3,5-triazine-2,4,6triamin; and

Lambda-cyhalothrine:
α-cyano-3-phenoxybenzyl-3-(2-chloro-3,3,3-trifluoroprop-1-enyl)-2,2-dimethylcyclopropane carboxylate, as a 1:1 mixture of (Z)-(1R,3R), R-ester and (Z)-(1S,3S), S-ester;

the repellent is selected from N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella), IR3535 (ethyl butylacetylaminopropionate), icaridin (1-piperidinecarboxylic acid 2-(2-hydroxyethyl)-1-methylpropylester).

A suitable mulloscicide is for example niclosamide.

Suitable rodenticides are first generation anticoagulant rodenticides and second generation anticoagulant rodenticides, whereby second generation rodenticides are preferred. Examples for first generation anticoagulant rodenticides are for example warfarin, chlorphacinone, coumatetralyl, suitable second generation anticoagulant rodenticides are for example flocoumafen, brodifacoum, difenacoum, bromadialone, difethialone, and bromethalin.

Suitable fungicides are for example antifungal agents used in the case of athlete's foot selected from the group consisting of clotrimazole: 1-(2-chlorotrityl)imidazole, miconazole: 1-[2-(2,4-dichlorophenyl)-2-[(2,4dichlorophenyl)methoxy]ethyl]-1H-imidazole, econazole 4-[2-[(4-chlorophenyl)methoxy]-2-(2,4-dichlorophenyl)-ethyl]-4H-imidazole, tioconazole: 1-[2-[(2-chloro-3-thienyl)methoxy]-2-(2,4-dichlorophenyl)-ethyl]-1H-imidazole, undecylenic acid, terbinafine hydrochloride: N,6,6-trimethyl-N-(naphthalen-4-ylmethyl)hept-2-en-4-yn-1-amine hydrochloride (lamisil topical), and tolnaftate: N-methyl-N-(m-tolyl)-1-naphthalen-3-yloxy-thioformamide.

Further suitable fungicides are
Azoles as Bitertanol, Bromoconazol, Cyproconazol, Difenoconazole, Dinitroconazol, Epoxiconazol, Fenbuconazol, Fluquiconazol, Flusilazol, Flutriafol, Hexaconazol, Imazalil, Ipconazol, Metconazol, Myclobutanil, Penconazol, Propiconazol, Prochloraz, Prothioconazol, Simeconazol, Tebuconazol Tetraconazol, Triadimefon, Triadimenol, Triflumizol, Triticonazol;
Strobilurine as Azoxystrobin, Dimoxystrobin, Fluoxastrobin, Kresoxim-methyl, Metominostrobin Orysastrobin, Picoxystrobin, Pyraclostrobin Trifloxystrobin;
Acylalanine as Benalaxyl, Metalaxyl, Mefenoxam, Ofurace, Oxadixyl;
Aminderivate as Aldimorph, Dodine, Dodemorph, Fenpropimorph, Fenpropidin, Guazatine, Iminoctadine, Spiroxamin, Tridemorph;
Anilinopyrimidine as Pyrimethanil, Mepanipyrim oder Cyprodinil;
Dicarboximide wie Iprodion, Myclozolin, Procymidon, Vinclozolin;
Zimtsäureamide und Analoge as Dimethomorph, Flumetover oder Flumorph;
Antibiotika as Cycloheximid, Griseofulvin, Kasugamycin, Natamycin, Polyoxin oder Streptomycin;
Dithiocarbamate as Ferbam, Nabam, Maneb, Mancozeb, Metam, Metiram, Propineb, Polycarbamat, Thiram, Ziram Zineb;
Heterocylische Verbindungen as Anilazin, Benomyl, Boscalid, Carbendazim, Carboxin, Oxycarboxin, Cyazofamid, Dazomet, Dithianon, Famoxadon, Fenamidon, Fenarimol, Fuberidazol, Flutolanil, Furametpyr, Isoprothiolan, Mepronil, Nuarimol, Picobenzamid, Probenazol, Proquinazid, Pyrifenox, Pyroquilon, Quinoxyfen, Silthiofam, Thiabendazol, Thifluzamid, Thiophanat-methyl, Tiadinil, Tricyclazol, Triforine M Anorganika;
Nitrophenyiderivate, as Binapacryl, Dinocap, Dinobuton, Nitrophthal-isopropyl;
Phenylpyrrole Fenpiclonil Fludioxonil;
Sulfensäurederivate Captafol, Captan, Dichlofluanid, Folpet, Tolylfluanid;
Sonstige Fungizide as Acibenzolar-S-methyl, Benthiavalicarb, Carpropamid, Chlorothalonil, Cyflufenamid, Cymoxanil, Dazomet, Diclomezin, Diclocymet, Diclofluanid, Diethofencarb, Edifenphos, Ethaboxam, Fenhexamid, Fentin-Acetat, Fenoxanil, Ferimzone, Fluazinam, Fosetyl, Fosetyl-Aluminium, Phosphorige Säure, Iprovalicarb, Hexachlorbenzol, Metrafenon, Pencycuron, Propamocarb, Phthalid, Toloclofos- methyl, Quintozene, Zoxamid.

Preferred insecticides and/or repellents of the insecticide composition of the present invention may be either one of a single insecticide and/or repellent or a mixture of insecticides and/or repellents selected from the group of insecticides and/or repellents that are suitable for application to a fabric material or a netting. Preferred mixtures of insecticides and/or repellents are mixtures of insecticides and/or repellents with similar diffusion/migration properties. This group of insecticides and/or repellents may include synthetic pyrethroids such as those known in the trade as alphacypermethrin, cyfluthrin, deltamethrin, etofenprox and permethrin, other pyrothreids such as that known in the trade as bifenthrine and non-pyrethroids such as that known in the trade as carbosulphane.

If the insecticides and repellants mentioned above have one or more chiral centers in their molecules, they may be applied as racemates, pure enantiomers or diastereomers or in chirally or diastereomerically enriched mixtures.

The insecticide and/or repellent mentioned in the present invention also may be included in the insecticide composition as one of a water-based insecticide and/or repellent concentrate or a solvent, preferably an organic solvent, based insecticide and/or repellent concentrate or a concentrate based on a mixture of water and a solvent, preferably an organic solvent. Water-based concentrates may be in the form of suspensions or dispersions comprising suitable dispersing agents if necessary or in the form of emulsions comprising emulsifiers, solvents and co-solvents if appropriate. Nanoparticular insecticidal formulations may be obtained by dissolving solid solutions of insecticides in a polar organic solvent, e.g. poly vinyl pyrrolidone (PVP). The concentration of the insecticide and/or repellent in the water based or solvent based concentrates is in general between 0.5 to 60%, preferably 1 to 40%, more preferably 3 to 20%.

The insecticide and/or repellent forming part of the insecticide composition of the present invention may also be selected from other groups suitable for different applications.

The particle size of the insecticide and/or repellent in water-based suspensions or dispersions is in general between 50 nm to 20 μm, preferably 50 nm to 8 μm, more preferably 50 nm to 4 μm, most preferably 50 nm to 500 nm.

Acrylic Binder (Component B1)

The acrylic binder is preferably obtainable by emulsion polymerization of
b1a) 10 to 90% by weight, preferably 15 to 80% by weight, more preferably 20 to 70% by weight of component B1A;
b1b) 10 to 90% by weight, preferably 12 to 85% by weight, more preferably 15 to 65% by weight of component B1B;
b1c) 1 to 5% by weight of component B1C;
b1d) 0 to 5% by weight, preferably 1 to 4% by weight, more preferably 0.2 to 3% by weight of component B1D;
b1e) further monomers which are copolymerizable with the monomers mentioned above selected from
   b1e1) 0 to 30% by weight, preferably 0 to 25% by weight, more preferably 5 to 20% by weight of component B1E1; and/or
   b1e2) 0 to 40% by weight, preferably 0 to 30% by weight, more preferably 5 to 20% by weight of component B1E2;
      wherein the sum of the components B1A, B1B, B1C and optionally B1D and B1E is 100% by weight.

In a further preferred embodiment the acrylic binder is obtainable by emulsion polymerization of
b1) 30 to 80% by weight, preferably 35 to 75% by weight, more preferably 35 to 70 by weight of at least one acrylic binder (component B1) as defined above, comprising;
   b1a) 10 to 90% by weight, preferably 15 to 85% by weight, more preferably 30 to 85% by weight based on the acrylic binder of n-butyl acrylate (component B1A);
   b1b) 10 to 90% by weight, preferably 12 to 85% by weight, more preferably 15 to 65% by weight based on the acrylic binder of at least one monomer of formula I (component B1B);
   b1c) 1 to 5% by weight based on the acrylic binder of at least one monomer of formula II (component B1C);
   b1d) 0 to 5% by weight, preferably 0.1 to 4% by weight, more preferably 0.2 to 3% by weight based on the acrylic binder of at least one monomer of formula III (component B1D);
   b1e) further monomers which are copolymerizable with the monomers mentioned (component B1E) above selected from
      b1e1) 0 to 30% by weight, preferably 0 to 25% by weight, more preferably 5 to 20% by weight based on the acrylic binder of at least one polar momomer, preferably (meth)acrylic nitrile and/or methyl(meth)acrylate (component B1E1); and/or
      b1e2) 0 to 40% by weight, preferably 0 to 30% by weight, more preferably 5 to 20% by weight based on the acrylic binder of at least one non polar momomer, preferably styrene and/or amethylstyrene (component B1E1);
         wherein the sum of the components B1A, B1B, B1C and optionally B1D and B1E is 100% by weight.

The acrylic binder may comprise further additives as known by a person skilled in the art, for example film forming agents and plastisizers, e.g. adipate, phthalate, butyl diglycol, mixtures of diesters preparable by reaction of dicarboxylic acids and alcohols which may be linear or branched. Suitable dicarboxylic acids and alcohols are known by a person skilled in the art.

The insecticide compositions comprising the specific binder as claimed in the present invention are wash resistant while permitting continuous release of the insecticide at a controlled rate, in order to provide the required bioavailability of the insecticide. It is not necessary to add for example a dispersing agent that, after application of the composition to a fabric and upon wetting of the fabric, reduces the hydrophobicity imparted to the insecticide by the binder to permit limited insecticide release. Preferably, the insecticide composition of the present invention does therefore not comprise a dispersing agent in addition to the acrylic binder.

Most preferably the acrylic binder is obtainable by emulsion polymerization of the following components:
b1a) 20 to 70% by weight of n-butylacrylate as component B1A;
b2b) 0 to 65% by weight of at least one monomer of formula I as component B1B 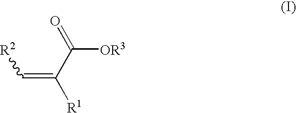
   wherein
   R¹ is H or methyl, R² is H and R³ is methyl, ethyl, or 2-ethylhexyl, as component B1B, most preferably component B1B is 2-ethylhexylacrylate, methylacrylate, methylmethacrylate or ethylacrylate;
b1c) 1 to 5% by weight of at least one monomer of formula II 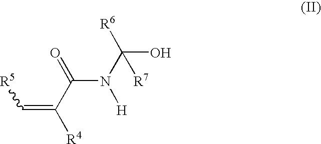
   wherein R⁴ is H or methyl, R⁵, R⁶ and R⁷ each are H as component B1C;
b1d) 1 to 10% by weight, preferably 1 to 7% by weight, more preferably 2 to 5% by
   weight of at least one monomer of formula III 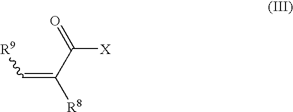
   wherein R⁸ and R⁹ are H and X is H, OH, NH₂, OR¹¹OH, glycidyl or a group of the formula 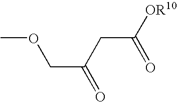
   wherein
   R¹⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
   R¹¹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene;
   as component B1D, most preferably X is acetoacetyl;
b1e) further monomers which are copolymerizable with the monomers mentioned above selected from
   b1e1) 0 to 30% by weight, preferably 0 to 25% by weight, more preferably 5 to 20% by weight of component B1E1, preferably (meth)acrylic nitrile and/or methyl(meth)acrylate;
   and/or
   b1e2) 0 to 40% by weight, preferably 0 to 30% by weight, more preferably 5 to 20% by weight of component B1E2, preferably styrene and/or amethylstyrene;
      wherein the sum of components B1A, B1B, B1C and optionally B1D and Bl E is 100% by weight.

In a further most preferred embodiment the amount of n-butylacrylate as component B1A is from 30 to 85% by weight, and the other components B1A, B1B, B1C and optionally B1D and B1E are chosen as mentioned before, wherein the sum of components B1A, B1B, B1C and optionally B1D and B1E is 100% by weight.

The acrylic binder of the present invention is obtainable by emulsion polymerization of the monomers mentioned before. Suitable process conditions are known by a person skilled in the art.

The monomers are polymerized under usual conditions of temperature and pressure, i.e. at from atmospheric pressure to 10 bar and in general at temperatures of from 20 to 100° C., preferably 50 to 85° C., depending on the initiator used. Usually the polymerization is carried out in a stirred reaction vessel under an inert atmosphere.

The copolymerization is generally carried out in water. However, it is also possible to add before, within or after the polymerization process up to 80% by weight, relating to the aqueous phase, of a lower alcohol like methanol, ethanol or isopropanol or a lower ketone like acetone. Preferably the copolymerization is carried out in water without addition of further solvents.

The polymerization process may be carried out continuously or batch-wise, and it is possible to employ the usual methods of batch-wise polymerization, e.g. mixing all polymerization components at once or feeding emulsified monomers and catalysts from one or more metering vessels to a batch containing a portion of a monomer. It is possible to add polymer seed to the polymerization mixture to adjust the particle size of the emulsion polymers obtained.

The emulsion polymerization is preferably carried out in the presence at least one initiator which form radicals under the polymerization conditions. Suitable initiators are for example all common peroxy compounds or azo compounds.

Suitable peroxides are for example alkali metal peroxodisulfates, for example sodium peroxodisulfate, ammonium peroxodisulfate; hydrogen peroxide; organic peroxides, for example diacetyl peroxide, di-tert-butyl peroxide, diamylperoxide, dioctanoyl peroxide, didecanoyl peroxide, dilauroyl peroxide, dibenzol peroxide, bis-(o-toloyl)peroxide, succinyl peroxide, tert-butyl peracetate, tert-butyl permaleinate, tert-butyl perpivalate, tertbutylperoctoate, tert-butyl pemeodecanoate, tert-butyl perbenzoate, tert-butyl peroxide, tert-butyl hydroperoxide, cumene hydroperoxide, tert-butyl-peroxy-2-ethylhexanoate, and diisopropyl peroxodicarbamate. Further suitable initiators are azo compounds, for example azobis isobutyronitrile, anzobis(2-amidopropane)dihydrochloride, and 2,2′-azobis(2-methylbutyronitrile).

The initiators are added in usual amounts, for example in an amount of 0.05 to 5% by weight, preferably 0.05 to 2% by weight, based on the total weight of monomers.

If the polymerization is carried out at low temperature, use may be made of conventional redox catalysts. For example, it is possible to use, in addition to the peroxide catalysts of the above kinds, from 0.05 to 2% by weight, based on the total of monomers, of reducing agents such as hydrazine, soluble oxidizable sulfoxy compounds such as alkali metal salts of hydrosulfites, sulfoxylates, thiosulfates, sulfites, and bisulfites, which may be optionally activated by the addition of traces of heavy metals, e.g. salts of Ce, Mo, Fe, and Cu, in the usual manner. Preferred redox catalysts are redox catalysts of acetone disulfite and organic peroxides like tert-C₄Hg—OOH; Na₂S₂O₅ and organic peroxides like tert-C₄—Hg—OOH; or HO—CH₂SO₂H and organic peroxides like tert-C₄Hg—OOH. Further preferred are redox catalysts like ascorbic acid and hydrogen peroxide.

The initiator may be added completely at the beginning of the polymerization, but it is also possible to add the initiator in the course of the emulsion polymerization process in a continuous or stepwise way. The way of adding the initiator is known in the art.

The polymerization process is carried out until a conversion of at least 95% by weight of the monomers is reached. For removal of the residual monomer at the end of the emulsion polymerization initiator may be added for chemical deodoration.

The emulsion polymerization is carried out by adding emulsifiers or mixtures of emulsifiers known in the art. The emulsifiers generally used are ionic (anionic or cationic) and/or non-ionic emulsifiers such as polyglycolethers, sulfonated paraffin hydrocarbons higher alkylsulfates such as oleyl amine, laurylsulfate, alkali metal salts of fatty acids such as sodium stearate and sodium oleate, sulphuric acid esters of fatty alcohols, ethoxylated C₈₋₁₂-alkylphenols, usually having from 5 to 30 ethylene oxide radicals, and their sulfonation products, and also suffosuccinic acid esters. The emulsifier or mixtures of emulsifiers are usually employed in an amount of 0.05 to 7% by weight, preferably 0.5 to 4% by weight, based on the total weight of monomers.

In some cases there is added a co-solvent or a mixture of co-solvents to the emulsifiers. Preferred co-solvents are aliphatic C₁- to C₃₀-alcohols which are linear or branched, alicyclic C₃- to C₃₀-alcohols and mixtures thereof. Examples are n-butanol, n-hexanol, cyclohexanol, 2-ethylhexanol, i-octanole, n-octanole, n-decanole, n-dodecanole, stearyl alcohol, oleyl alcohol or cholesterol. Further possible co-solvents are alkane diol, ethylene glycol alkyl ethers, N-alkyl pyrrolidones, and N-alkyl and N,N-dialkyle acid amides like ethylene glycol monobutyl ether, diethylen glycol monoethyl ether, tetraethylen glycol dimethyl ether, N-methyl pyrrolidone, N-hexyl pyrolidone, di-ethyl acid amide or N-octyl acid amide. The co-solvents or mixture of co-solvents is added in an amount of 0 to 20% by weight, preferably 1 to 5% by weight. In many cases use is also made of a protective colloid, examples of which are polyvinyl alcohol, partially saponified polyvinyl acetates, cellulose derivatives, copolymers of methyl acrylate with acrylic amide and methylacrylic amide or vinyl pyrrolidine polymers in amounts of from 0.5 to 10% by weight and in particular 1.0 to 5% by weight of the weight of the monomers.

Further, it is possible to add in general up to 10% by weight, preferably 0.05 to 5% by weight of mono- or di-olefinically unsaturated monomers containing reactive or cross-linking groups. Examples of such monomers are in particular the amides of α,β-olefinically unsaturated C₃₋₅-carboxylic acids, particularly acryl amides, methacryl amides and maleic diamides, and their N-methylol derivatives such as N-methylol acrylic amide, N-methylol methacrylic amide, N-alkoxy methyl amides of α,β758 -monoolefinically unsaturated C₃₋₅-carboxylic acids such as N-methoxy methacrylic amide and N-n-butoxymethylacrylic amide, vinyl sulfonic acid, monoesters of acrylic and methacrylic acids with alkanediols such as glycol, butanediol-1,4, hexane diol-1,6, and 3-chloropropanediol-1,2, and also allyl and methallyl esters of α,β-olefinically unsaturated mono- and di-carboxylic acids such as diallyl maleate, dimethyl allyl fumarate, allyl acrylate and allyl methacrylate, diallyl phthalate, diallyl terephthalate, p-di-vinyl benzene, methylene-bis-acrylamide and ethylene glycol di-allylether.

The solids content of the aqueous dispersions of polymers obtained in the emulsion polymerization is usual 15 to 75% by weight, preferably 25 to 50% by weight. To obtain high space time yields of the reactor dispersions having a high solids content are preferred. To obtain solids contents of more than 60% by weight a bi- or polymodal particle distribution should be adjusted, because otherwise it is not possible to handle the dispersion, because of the high viscosity. New particle generations (for obtaining bi- or polymodel particle size distribufions) are for example formed by addition of seed (EP-A 0 810 831), addition of an excess of emulsifier or addition of mini-emulsions. The formation of new particle generations may be carried out at any time and is depending on the desired particle size distribution for a low viscosity.

The molecular weight of the non crosslinked emulsion polymers obtained is in general 40,000 to 250,000 (determined by GPC). The molecular weight is usually controlled by the use of conventional chain stoppers in conventional amounts. Conventional chain stoppers are for example sulfoorganic compounds.

The acrylic binder of the present invention is obtained in form of its aqueous dispersion and is preferably employed in the insecticide compositions of the present invention in form of the aqueous dispersion.

Polyurethane (Component B2)

The polyurethane is preferably obtainable by reaction of the following components:
b2a) 55 to 99% by weight, preferably 70 to 98% by weight, more preferably 75 to 90 by weight based on the polyurethane of at least one diisocyanate or polyisocyanate (component B2a), preferably aliphatic, cycloaliphatic, araliphatic and/or aromatic insocyanates, more preferably diisocyanates, which are optionally biuretisized and/or isocyanurized, more preferably alkylene diisocyanates having from 4 to 12 carbon atoms in the alkylene unit, like 1,12-dodecane diisocyanate, 2-ethyltetramethylene diisocyanate-1,4,2-methylpentamethylene diisocyanate-1,5, tetramethylene diisocyanate-1,4, lysinester diisocyanate (LDI), hexamethylene diisocyanate-1,6 (HMDI), ciclohexane-1,3-and/or-1,4-diisocyanate, 2,4-and 2,6-hexahydro-toluylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before; further ester-, urea-, allophanate-, carbodiimid-, uret- dione- and/or urethane groups comprising di- and/or polyisocyanates may be used; most preferably 1-isocyanato-3,3,5-trimethyl-5-isocyanatomethylene cyclohexane (IPDI) and hexamethylene diisocyanate-1,6 (HMDI);
b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably polyols, selected from the group consisting of polyetherols, e.g. polytetrahydrofurane, polyesterols, polythioetherpolyols, hydroxyl group containing polyacetales and hydroxyl group containing aliphatic polycarbonates or mixtures of at least 2 of the polyols mentioned before. Preferred are polyesterols and/or polyetherols. The hydroxyl number of the polyhydroxy compounds is in general from 20 to 850 mg KOH/g and preferably 25 to 80 mg KOH/g. Further, diols and/or triols having a molecular weight of from in general 60 to <400, preferably from 60 to 300 g/mol are employed. Suitable diols are aliphatic, cycloaliphatic and/or araliphatic diols having from 2 to 14, preferably 4 to 10 carbon atoms, e.g. ethylene glycol, propane diol-1,3, decane diol-1,10, o-, m-, p-dihydroxycyclohexane, diethylene glycol, dipropylene glycol and preferably butane diol-1,4, neopentyl glycol, hexane diol-1,6 and bis-(2-hydroxy-ethyl)hydroquinone, triols, like 1,2,4-, 1,3,5-trihydroxy-cyclohexane, glycerine and trimethylol propane and mixtures of low molecular hydroxyl groups containing polyalkylene oxides based on ethylene oxide and/or 1,2-propylene oxide and the diols and/or triols mentioned before;
b2c) 0 to 10% by weight, preferably 0.1 to 5% by weight, more preferably 1 to 5% by weight based on the polyurethane of further components (component B2C), preferably adipic acid or carbonyl diimidazole (CDI); and
b2d) 0 to 10% by weight, preferably 0.1 to 5% by weight, more preferably 0.5 to 5% by weight based on the polyurethane of further additives (component B2D);
   wherein the sum of the components B2A, B2B, B2C and B2D is 100% by weight.

The polyurethanes are prepared by methods known in the art. Further, additives as known by a person skilled in the art may be used in the process for preparing the polyurethanes.

Insecticide Compositions

Depending on the use of the final product the insecticide composition of the present invention may further comprise one or more components selected from water, preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide ecomposing agents and the like, flame retardants, mould release agents, agents having UV protecting properties, optical brighteners, spreading agents, anti-blocking agents, anti-migrating agents, foam-forming agents, anti-soiling agents, thickeners, urther biocides, wetting agents, plasticizers and film forming agents, adhesive or anti-adhesive agents, optical brightening (fluorescent whitening) agents, fragrance, pigments and dyestuffs.

The insecticide compositions of the present invention may be aqueous compositions comprising water or dry compositions, e.g. compositions which do not comprise water. Preferably, the insecticide compositions are aqueous compositions, preferably comprising 0.1 to 45% by weight, more preferably 1 to 25% by weight of water, based on the total of the components in the insecticide compositions of the present invention except of water.

In a further preferred embodiment the ready-to-use insecticide compositions are aqueous compositions, preferably comprising 55 to 97% by weight, more preferably 85 to 95% by weight of water, and 3 to 45% by weight, preferably 5 to 15% by weight of solids, based on the total of the components in the insecticide compositions of the present invention, wherein the total is 100% by weight. The solids are preferably selected from the group consisting of at least one insecticide and/or repellent as component A as defined above, and at least one acrylic binder as component B1 as defined above and instead of component B1 or in addition to component B1 at least one polyurethane as component B2 as defined above, and optionally at least one fixative agent as component C as defined below, and optionally further components depending on the use of the final product as defined above.

The treatment baths from which the insecticide compositions are applied to the textile material or plastics material are preferably aqueous formulations comprising 95 to 99.5% by weight, preferably 95 to 99% by weight, more preferably 97 to 99% by weight of water, based on the total of the components in the insecticide compositions of the present invention.

Suitable anti-foam agents are for example silicon anti-foam agents. Suitable UV-protecting agents for protecting UV-sensitive insecticides and/or repellents are for example para-aminobenzoic acids (PABA), octylmethoxysinameth, stilbenes, styryl or benzotriazole derivatives, benzoxazol derivatives, hydroxy-substituted benzophenones, salicylates, substituted triazines, cinnamic acid derivatives (optionally substituted by 2-cyano groups), pyrazoline derivatives, 1,1′-biphenyl-4,4′-bis-2-(methoxyphenyl)-ethenyl or other UV protecting agents. Suitable optical brighteners are dihydroquinolinone derivatives, 1,3diaryl pyrazoline derivatives, pyrenes, naphthalic acid imides, 4,4′- di-ystyryl biphenylene, 4,4′-diamino-2,2′-stilbene disulphonic acids, cumarin derivatives and benzoxazole, benzisoxazole or benzimidazole systems which are linked by —CH═CH-bridges or other fluorescent whitening agents.

Typical pigments used in the insecticide compositions of the present invention are pigments which are used in pigment dyeing or printing processes or are applied for the coloration of plastics and are known by a person skilled in the art.

Pigments may be inorganic or organic by their chemical nature. Inorganic pigments are mainly used as white pigments (e.g., titanium dioxide in the form of rutile or anatas, ZnO, chalk) or black pigments (e.g., carbon black). Colored inorganic pigments may be used as well but are not preferred because of potential toxicologic hazards. For imparting color, organic pigments or dyestuffs are preferred. Organic pigments may be mono or disazo, naphthol, benzimidazolone, (thio) indigoid, dioxazine, quinacridone, phthalocyanine, isoindolinone, perylene, perinone, metal complex or diketo pyrrolo pyrrole type pigments. Pigments may be used in powder or liquid form (i.e., as a dispersion). Preferred pigments are Pigment Yellow 83, Pigment Yellow 138, Pigment Orange 34, Pigment Red 170, Pigment Red 146, Pigment Violet 19, Pigment Violet 23, Pigment Blue 15/1, Pigment Blue 15/3, Pigment Green 7, Pigment Black 7. Other suitable pigments are known to a person skilled in the art.

Typical dyestuffs which may be used in the present invention are vat dyes, cationic dyes and disperse dyes in powder or liquid form. Vat dyes may be used as pigments or following the vatting (reduction) and oxidation procedure. Using the vat pigment form is preferred. Vat dyes may be of the indanthrone type, e.g. C.I. Vat Blue 4, 6 or 14; or of the flavanthrone type, e.g. C.I. Vat Yellow 1; or of the pyranthrone type, e.g. C.I. Vat Orange 2 and 9; or of the isobenzanthrone (isoviolanthrone) type, e.g. C.I. Vat Violet 1; or of the dibenzanthrone (violanthrone) type, e.g. C.I. Vat Blue 16, 19, 20 and 22, C.I. Vat Green 1, 2 and 9, C.I. Vat Black 9; or of the anthraquinone carbazole type, e.g. C.I. Vat Orange 11 and 15, C.I. Vat Brown 1, 3 and 44, C.I. Vat Green 8 and C.I. Vat Black 27; or of the benzanthrone acridone type, e.g. C.I. Vat Green 3 and 13 and C.I. Vat Black 25; or of the anthraquinone oxazole type, e.g. C.I. Vat Red 10; or of the perylene tetra carbonic acid diimide type, e.g. C.I. Vat Red 23 and 32; or imidazole derivatives, e.g. C.I. Vat Yellow 46; or amino triazine derivatives, e.g. C.I. Vat Blue 66. Other suitable vat dyes are known by a person skilled in the art.

Typical disperse and cationic dyestuffs are known by a person skilled in the art.

If cellulosic substrates are employed as textile material, said cellulosic substrates are preferably dyed with vat, direct, reative or sulphur dyestuffs.

In a further embodiment the insecticide compositions of the present invention are insecticide compositions as mentioned before comprising at least one pigment and/or at least one dyestuff. The insecticide compositions of the present invention preferably comprise 10 to 300% by weight, more preferably 20 to 150% by weight of the pigment and/or dyestuff relating to the total weight of the solids content of the insecticide and/or repellent.

It is also possible to use pre-dyed textile material or plastics material, preferably netting material, to which the insecticide composition of the present invention is applied. Suitable pigments and dyestuffs for dying the textile material or plastics material are mentioned above. Suitable dyeing processes are known by a person skilled in the art. If polyester substrates are employed as textile material or plastics material, said polyester substrates are preferably dyed with disperse dyes, preferably by exhaust or continuous dyeing, e.g. by the thermosol process. If polyamide substrates are employed as textile material or plastics material, said polyamide substrates are preferably dyed with anionic, acidic or metal-complex dyestuffs or spin/mass dyed.

Textile material or plastics material to be impregnated according to the present invention and by use of a composition as described in the present invention may be impregnated locally when the composition is delivered in the form of a kit comprising the ingredients of the insecticide composition in a handy form. In a further embodiment the present invention therefore relates to an insecticide composition as described in the present invention which is provided as a kit for impregnation by the end-user or in a local factory. In a preferred embodiment the kit is adapted for preparing a solution or emulsion by adding water. The ingredients of the kit may accordingly be in form of a dry composition such as a powder, a capsule, a tablet, or an effervescent tablet. In a further embodiment, the kit comprises an emulsion wherein water is added by the end-user or in a local factory. The emulsion may be a micro-emulsion, which is generally very stable. The emulsion may be embodied in a capsule.

The kit comprises at least the following ingredients:
a) at least one insecticide and/or at least one repellent, and
b1) at least one acrylic binder as described in the present invention;
and/or
b2) at least one polyurethane as described in the present invention.

Preferred insecticides and/or repellents as well as preferred acrylic binders and preferred polyurethanes are already mentioned in the present invention. The kit may contain further ingredients as mentioned above, especially one or more compounds selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, fragrance, pigments and dyestuffs. Preferred kits comprise beside the insecticide and/or repellent and the acrylic binder and/or the polyurethane at least one pigment and/or at least one dyestuff. Preferred pigments and dyestuffs are mentioned before.

In a further embodiment the present invention relates to an impregnated textile material or plastics material for insect killing and/or repellence of an insect comprising
a) at least one insecticide and/or at least one repellent, and
b1) at least one acrylic binder as disclosed in the present invention;
and/or
b2) at least one polyurethane as disclosed in the present invention.

Preferred insecticides and/or repellents and preferred acrylic binders and polyurethanes are mentioned before. Materials of the textile material or plastics material and preferred textile material or plastics material are also mentioned before.

A typical amount of insecticide and/or repellent in the impregnated textile material or plastics material is from 0.01 to 10% (dry weight) of the (dry) weight of the fabric material or netting dependent on the insecticidal efficiency of the insecticide respectively the efficiency of the repellent. A preferred amount is between 0.05 and 7% by weight of the textile material or plastics material depending on the insecticide and/or repellent. For a pyrethroid like deltamethrin or alphacypermethrin, the preferred amounts are between 0.1 and 3.5% of the weight of the textile material or plastics material. For a pyrethroid like permethrin or etofenprox, the preferred amount is from 0.1 to 6%.

A typical amount for the acrylic binder and/or the polyurethane is from 0.001 to 10% by weight (dry weight) of the (dry) weight of the textile material or plastics material. As a rule, the higher amount the insecticide of the specific type to be added, the higher the concentration of the acrylic binder and/or the polyurethane so that the ratio between insecticide and acrylic binder and/or the polyurethane is approximately constant with a value depending on the insecticidal and migratory ability of the insecticide. Preferred amounts of acrylic binder and/or polyurethane are from 0.1 to 5% by weight, more preferably 0.2 to 3% by weight of the (dry) weight of the textile material or plastics material.

In a further embodiment, the impregnated textile material or plastics material according to the present invention further comprises one or more components selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, pigments and dyestuffs. Suitable examples of the components mentioned above are known by a person skilled in the art.

In a further embodiment of the present invention the impregnated textile material or plastics material comprises besides the at least one insecticide and/or repellent and the at least one acrylic binder and/or polyurethane as described before at least one pigment and/or at least one dyestuff. The amount of the at least one pigment is in general from 0.05 to 10% by weight, preferably 0.1 to 5% by weight, more preferably 0.2 to 3.5% by weight of the (dry) weight of the textile material or plastics material. The amount of the at least one dyestuff is in general from 0.05 to 10% by weight, preferably 0.1 to 5% by weight, more preferably 0.2 to 3.5% by weight of the (dry) weight of the textile material or plastics material. The textile material or plastics material comprises preferably either at least one pigment or at least one dyestuff. Suitable pigments and dyestuffs are mentioned before.

Process for Impregnation of a Textile Material or Plastics Material

In a further embodiment, the present invention relates to a process for impregnation of a textile material or plastics material comprising
i) forming an aqueous formulation or a melt, wherein an aqueous formulation is preferred, comprising at least one insecticide and/or at least one repellent and at least one acrylic binder and/or at least one polyurethane as defined in the present invention and optionally further ingredients;
ii) applying the aqueous formulation to the textile material or plastics material by
   iia) passing the textile material or plastics material through the aqueous formulation;
   or
   iib) bringing the textile material or plastics material in contact with a roller that is partly or fully dipped into the aqueous formulation and drawing the aqueous formulation to the side of the textile material or plastics material in contact with the roller,
   or
   iic) double-side coating of the textile material or plastics material
   or
   iid) spraying the aqueous formulation onto the textile material or plastics material, wherein the spraying is carried out with any suitable device for spraying by hand or automatically, for example with an aerosol can or devices usually used in a factory;
   or
   iie) applying the aqueous formulation in form of a foam;
   or
   iif) submerging the textile material or plastics material into the aqueous formulation;
   or
   iig) brushing the aqueous formulation onto or into the textile material or plastics material;
   or
   iih) pouring the aqueous formulation onto the textile material or plastics material;
   or
   applying the melt by calandering or with a doctor-blade;
iii) optionally removing surplus aqueous formulation or surplus melt; and
iv) drying and/or curing the textile material or plastics material.

In the context of the present invention an aqueous formulation may be a solution, an emulsion or a suspension/dispersion.

The aqueous formulation or the melt preferably comprises the insecticide composition as disclosed in the present invention, which is preferably employed in form of an aqueous formulation.

In the context of the present invention “impregnation” is a process for applying the insecticide composition. This process may include a process for curing the applied insecticide composition to achieve a coating onto the textile material or plastics material, if desired. An “impregnated textile material or plastics material” is a material onto which the insecticide composition is applied. The “impregnated textile material or plastics material” may be coated by curing the applied insecticide composition, if desired.

The insecticide composition of the present invention may also be applied onto the textile or plastics material by transfer printing, inkjet printing, a screen process, and powder printing.

Suitable textile materials or plastics materials are mentioned before. It is possible to impregnate the textile or plastics material in form of its finished product (end of line treatment, discontinuous treatment). In this case no further pass is necessary after impregnation. However, it is also possible to impregnate the textile or plastics material in form of a yam or fibers, which have to be further processed after impregnation to obtain the desired finished product (in line treatment). Preferred insecticides and/or repellents used are also defined before as well as preferred acrylic binders and/or polyurethanes.

The discontinuous treatment may be performed in factories, in local treatment centers (local factories) or even with mobile equipment which is e.g. mounted on trucks or pickups (e.g. in re-treatment antimalaria campaigns). The discontinuous treatment may be done on new (untreated textile materials oer plastics materials, preferably nettings, in use or made-up form (preferably as nets) or on used textile materials or plastics materials (preferably nets), preferably after washing.

It is one advantage of the present invention that the impregnation is carried out in an aqueous formulation or in a melt. It is not necessary to add any organic solvents. In a preferred embodiment of the present invention the treatment bath is an aqueous formulation which does not comprise any further solvents, especially no organic solvents.

It is advantageous to avoid the use of organic solvents because the textile material or plastics material of the present invention may be used in close contact to the human body. The textile material or plastics material impregnated by the method of the present invention does not comprise any organic solvent residue which is beneficial both from a human toxicological and an ecological point of view.

The aqueous formulation or the melt employed in the impregnation process may further comprise one or more ingredients selected from the group consisting of preservatives, detergents, stabilisers, agents having UV-protecting properties, spreading agents, anti-migrating agents, foam-forming agents, wetting agents, anti-soiling agents, thickeners, further biocides, plasticizers, adhesive agents, fragrance, pigments and dyestuffs.

In a further embodiment the aqueous formulations or the melts employed for impregnation of the textile material or plastics material comprise in addition to the at least one insecticide and/or repellent and the at least one acrylic binder and/or at least one polyurethane at least one pigment and/or at least one dyestuff. These aqueous formulations or melts are suitable for impregnation of the textile material or plastics material with at least one insecticide and/or repellent and additionally coloring the textile material or plastics material at the same time. Many of the textile materials or plastics materials which are impregnated with at least one insecticide and/or repellent are preferably colored. With the process of the present invention it is possible to color and impregnate the textile material or plastics material with an insecticide and/or repellent at the same time. The method of the present invention is therefore very economical, because the coloring and impregnation with an insecticide and/or repellent is carried out in one step.

In a further embodiment of the present invention the present invention therefore relates to a process for impregnation of a textile material or plastics material as described before, wherein the dyeing of the textile material or plastics material is carried out simultaneously with the impregnation of the textile material or plastics material, wherein an aqueous formulation is formed further comprising at least one dyestuff and/or at least one pigment.

Suitable amounts of pigments are in general 0.01 to 20% by weight, preferably 0.1 to 10% by weight, more preferably 0.2 to 5% by weight, based on the weight of the aqueous formulation used for impregnation. Suitable dyestuffs are employed in general in an amount of from 0.01 to 20% by weight, preferably 0.1 to 10% by weight, more preferably 0.2 to 5% by weight, based on the weight of the aqueous formulation used for impregnation.

Step i) Forming an Aqueous Formulation Comprising an Insecticide and/or Repellent and at Least One Crylic binder and/or at Least One Polyurethane and Optionally Further Ingredients

The aqueous formulation is formed by mixing all ingredients necessary for impregnation of the textile material or plastics material with water. The aqueous formulation is generally formed at temperatures of from 10 to 70° C., preferably 15 to 50° C., more preferably 20 to 40° C. Suitable aqueous formulations comprise an insecticide composition for application to a textile material or plastics material as described in the present invention.

Step ii) Applying the Aqueous Formulation Comprising an Insecticide and/or Repellent and at Least One Acrylic Binder and/or at Least One Polyurethane and Optionally Further Ingredients to the Textile Material or Plastics Material

Step iia)

The insecticide composition is applied by passing the textile material or plastics material through the aqueous formulation. This step is known by a person skilled in the art as padding. In a preferred embodiment the textile material or plastics material is completely submerged in the aqueous treatment liquor (aqueous formulation) either in a trough containing the liquor or passed through the treatment bath (aqueous formulation) which is held between two horizontally oriented rollers.

In accordance with the invention, the textile material or plastics material may either be passed through the aqueous formulation or the aqueous formulation may be passed through the textile material or plastics material. These processes are preferred for impregnating open-width material which is later tailored into nets. For small-scale production or re-impregnating of non-treated nets, use of a simple hand-held roller might be sufficient.

Step iib)

It is further possible to apply the aqueous formulation onto the textile material or plastics material by one-side only-coating applications methods. Suitable one-side only-coating application methods are for example knife-/doctor-blade-coating, roller coating or screen-printing. By this methods it is possible to impregnate only one side of the textile material or plastics material which is advantageous, if e.g. direct contact of the human skin with insecticide-treated material is to be avoided.

Knife-/doctor-blade-coating systems are for example knife-over-air-systems, knife-over-roller systems, knife-over-table systems or knife-over-rubber-belt systems. Further knife coating systems are for example commabar or Mayerbar knife systems.

Roller-coating systems are for example kiss-coating systems with one, two, three or more rollers, reverse-roll-coater systems and raster roll systems. In these roller-coating systems at least one roller is partly dipped into the aqueous formulation thus applying the aqueous formulation to the side of the textile material or plastics material in contact with the roller (kiss-rolling).

Screen-printing systems are for example rotary-screen printing systems and flat-screen printing systems. With these applications methods a dot coating or a full-surface coating can be applied to the textile material or the plastics material, for example by using an additional whisper-blade behind the rotary-screen.

A person skilled in the art will adjust the viscositiy of the aqueous formulation used by applying thickeners where appropriate.

Step iic)

It is further possible to apply the aqueous formulations to the textile material or plastics material by double-side coating application methods, for example double-side knife-coating systems, foulard with two air-knifes or foulard with squeezing rollers.

By using the double-side-knife-coating system or by passing two times through a one-side-only coating system, it is possible to apply the aqueous formulation only to the surfaces of both sides of the textile material or plastics material and thus to reduce the quantitiy of the aqueous formulations needed for a certain effect.

Step iid) and step iie)

It is further possible to apply the aqueous formulation by spraying the solution or emulsion onto the textile material or plastics material. Further it is possible, to apply the emulsion in the form of a foam which is applied to the textile material or plastics material. A foam comprises less water than the solution or emulsion mentioned above. The drying process may therefore be very short.

Step iif), iig) and Step iih)

It is further possible to apply the aqueous formulation onto the textile material or plastics material by submerging the textile material or plastics material into the aqueous formulation, brushing the aqueous formulation onto or into the textile material or plastics material, or pouring the aqueous formulation onto the textile material or plastics material. Said methods are known by a person skilled in the art.

Impregnation of the fabric material or netting in step iia), iib), iic), iid), iie), iif, iig), or iih) is carried out at temperatures of in general from 10 to 70° C., preferably 15 to 50° C., more preferably 20 to 40° C.

Step iii) Optionally Removing the Surplus Aqueous Formulation

The surplus aqueous formulation is usually removed by squeezing the textile material or plastics material, preferably by passing the textile material or plastics material rollers as known in the art, preferably by means of doctor blade, thus achieving a defined liquor uptake. The squeezed-off liquor is usually re-used.

The surplus aqueous formulation may alternatively be removed by centrifuging or vacuum suction.

Step iv) Drying and/or Curing the Textile Material or Plastics Material

The drying is in general carried out temperatures below 200° C. Preferred temperatures are from 50 to 170° C., more preferably from 70 to 150° C. The temperature choice is a function of the evaporation temperature and mobility of the insecticide in the formulation.

It should be noted that the drying process may be a passive drying as the process may be carried out in rather hot climates. An active drying process would normally be performed during high scale processing.

After or simultaneously to the drying, the impregnated textile material or plastics material is optionally finally cured and/or fixated. A person skilled in the art knows how to carry out a curing and/or fixation. The curing process is in general carried out at a temperature which may be higher than the drying temperature. Preferred temperatures for curing are 60 to 170° C., preferably 70 to 170° C., more preferably 80 to 150° C. Drying and curing can be advantageously be performed during one single process, e.g. in stenters with different compartments which can be heated to different temperatures. If a reactive crosslinking agent is used temperatures may be lower, e.g. 30 to 130° C., preferably 30 to 100° C.

The drying and/or curing may be achieved in any equipment usually applied in textile mills for these purposes, such as stenters, loop dryers, hotflues, tumble dryers, pad steam machines etc. In one embodiment of the present invention, equipment for continuous drying and/or curing is applied. In another embodiment of the present invention, equipment for discontinuous (batch-wise) drying and/or curing is used. Such equipment may comprise rotary or tumble dryers used in professional laundries, combined laundry/dryers which may be heated to the treatment temperatures, e.g. jeans stone-wash. The treatment chemicals may be added as a liquid or be sprayed onto the netting material and then brought to a homogeneous distribution by rotating the wet material before or during drying/curing. The treatment liquor may be added in excess if it is possible to remove the excess liquor e.g. by centrifuging. A person skilled in the art will be aware that treatment times might be longer than in the continuous process at the same temperature.

The curing process may also include or consist of passing the textile material or plastics material by a heated surface under pressure such as an iron or a heated roller. During drying processes and curing the textile material or plastics material is preferably mechanically fixated in a way to prevent change of the form e.g. shrinkage or dimensional deformation. Further, is is prevented that the insecticide and/or repellent is washed out. The curing and/or fixation may be alternatively carried out by a dual-cure process combining heat and UV-light or only by UV-light. Suitable processes are known by a person skilled in the art.

The acrylic binder and/or the polyurethane may advantageously be applied with a fixative agent for improved attachment of the insecticide and/or repellent on the textile material or plastics material. The fixative agent may comprise free isocyanate groups.

Suitable fixative agents are for example isocyanurates comprising free isocyanate groups. Preferably the isocyanurates are based on alkylene diisocyanates having from 4 to 12 carbon atoms in the alkylene unit, like 1,12-dodecane diisocyanate, 2-ethyltetramethylene diisocyanate-1,4, 2-methylpentamethylene diisocyanate-1,5, tetramethylene diisocyanate-1,4, lysinester dilsocyanate (LDI), hexamethylene dilsocy-anate-1,6 (HMDI), cyclohexane-1,3-and/or-1,4-diisocyanate, 2,4-and 2,6-hexahydro-toluylene diisocyanate as well as the corresponding isomeric mixtures 4,4′-2,2′- and 2,4′-dicyclohexylmethane diisocyanate as well as the corresponding mixtures, 1-isocyanato-3,3,5trimethyl-5-isocyanatomethyl cyclohexane (IPDI), 2,4- and/or 2,6-toluylene diisocyanate, 4,4′-, 2,4′ and/or 2,2′-diphenylmethane diisocyanate (mono-meric MDI), polyphenylpolymethylene polyisocyanate (polymeric MDI) and/or mixtures comprising at least 2 of the isocyanates mentioned before. More preferably the isocyanurates are based on hexamethylene diisocyanate-1,6 (HMDI).

More preferably the isocyanurate is a isocyanurate which is hydrophilized with a polyalkylene oxide based on ethylene oxide and/or 1,2-propylene oxide, preferably polyethylene oxide.

The isocyanurate used as fixative agent can be prepared by methods known in the art. Preferably 5 to 25% by weight, more preferably 7 to 20% by weight, most preferably 10 to 15% by weight of the isocyanate groups based on the amount of isocyanate used as staring material for the preparation of the isocyanurate are free isocyanate groups.

Most preferably the isocyanurate used as fixative agent is dissolved in a polar aprotic solvent, e.g. THF, DMF or propylene or ethylene carbonate.

The most preferred fixative agent used is an isocyanurate based on HMDI which are hydrophilized with a polyethylene oxide and which is dissolved in propylene carbonate (70% by weight of HMDI in 30% by weight of propylene carbonate). The amount of free isocyanate groups is 11 to 12% by weight, based on the amount of isocyanate used as staring material for the preparation of the isocyanurate.

The insecticide composition preferably comprises the following components, based on the solids content of the composition, if a fixative agent is used:
a) 20 to 70% by weight, preferably 25 to 65% by weight, more preferably 30 to 65% by weight of at least one insecticide and/or at least one repellent (component A), and
   b1) 29 to 72% by weight, preferably 34 to 70% by weight, more preferably 33 to 66 by weight of at least one acrylic binder (component B1) as defined above, comprising;
      b1a) 10 to 90% by weight, preferably 15 to 80% by weight, more preferably 20 to 70% by weight based on the acrylic binder of n-butyl acrylate (component B1A);
      b1b) 10 to 90% by weight, preferably 12 to 85% by weight, more preferably 15 to 65% by weight based on the acrylic binder of at least one monomer of formula I (component B1B);
      b1c) 1 to 5% by weight based on the acrylic binder of at least one monomer of formula II (component B1C);
      b1d) 0 to 5% by weight, preferably 1 to 4% by weight, more preferably 0.2 to 3% by weight based on the acrylic binder of at least one monomer of formula III (component B1D);
      b1e) further monomers which are copolymerizable with the monomers mentioned (component B1E) above selected from
         b1e1) 0 to 30% by weight, preferably 0 to 25% by weight, more preferably 5 to 20% by weight based on the acrylic binder of at least one polar momomer, preferably (meth)acrylic nitrile and/or methyl(meth)acrylate (component B1E1); and/or
         b1e2) 0 to 40% by weight, preferably 0 to 30% by weight, more preferably 5 to 20% by weight based on the acrylic binder of at least one non polar momomer, preferably styrene and/or amethylstyrene (component B1E1);
and/or
   b2) 29 to 72% by weight, preferably 34 to 70% by weight, more preferably 33 to 66 by weight of at least one polyurethane (component B2) as defined above, comprising:
      b2a) 55 to 99% by weight, preferably 70 to 98% by weight, more preferably 75 to 90 by weight based on the polyurethane of at least one diisocyanate or polyisocyanate (component B2A), preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
      b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably 1 ,6-hexanediol or neopentyl glycol;
      b2c) 0 to 10% by weight, preferably 0.1 to 5% by weight, more preferably 1 to 5% by weight based on the polyurethane of further components (component B2C), preferably adipic acid or carbonyl diimidazole (CDI); and
      b2d) 0 to 10% by weight, preferably 0.1 to 5% by weight, more preferably 0.5 to 5% by weight based on the polyurethane of further additives (component B2D)
c) 1 to 8% by weight, preferably 1 to 5% by weight, more preferably 2 to 4% by weight of at least one fixative agent (component C);
wherein the sum of the components is 100% by weight of solids content of the insecticide composition.

Preferred fixative agents are mentioned before.

As described above, the solution or emulsion may further comprise one or more components selected from water, preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide decomposing agents and the like, flame retardants, mould release agents, agents having UV protecting properties, spreading agents, anti-blocking agents, anti-migrating agents, foam-forming agents, anti-soiling agents, thickeners, further biocides, wetting agents, plasticizers, adhesive or anti-adhesive agents, optical brightening (fluorescent whitening) agents, fragrance, pigments and dyestuffs.

The process may also involve using the kit as described before, accordingly, the impregnation process may be carried out by the end-user in a low-scale process or in a local factory. The present invention therefore relates to a process for impregnating a fabric material or netting as described before, wherein the impregnating composition is provided as a kit for impregnation by the end-user or in a local factory.

In a further embodiment of the present invention the impregnation process which comprises applying an insecticide composition as described before may also take place before the fibers are woven or knitted.

In a further embodiment the invention relates to a process for coating a textile material or plastics material by applying a composition comprising at least one insecticide and/or at least one repellent and at least one acrylic binder and/or at least one polyurethane as defined in the present invention to the textile material or plastics material. The coating is preferably carried out in a doctor-blade process. The process conditions are known by a person skilled in the art.

Preferred compositions for coating a textile material or plastics material and preferred further ingredients of the composition are already mentioned above.

In a further embodiment the present invention relates to an exhaust process for impregnation of a textile material or plastics material comprising the steps
i) placing the textile material or plastics material in an aqueous bath optionally comprising further additives contained in a pressure-proof vessel;
ii) adding an aqueous formulation comprising at least one insecticide and/or repellent;
iii) heating the aqueous bath to a temperature of 100 to 140° C. and keeping the temperature for 20 to 120 minutes;
and
iv) cooling and draining the bath, and rinsing and drying the impregnated textile material or plastics material.

It was found by the inventors that the insecticide and/or repellent is not washed out and the bioavailability of the insecticide and/or repellent for killing insects is maintained after multiple washes by carrying out the impregnation of a textile material or plastics material by the process mentioned above, even in absence of a binder or a polyurethane. The aqueous bath and the aqueous formulation comprising at least one insecticide and/or repellent preferably do not comprise a binder or a polyurethane.

Suitable textile materials and plastics materials are the textile materials and plastics materials described before. Suitable insecticides and/or repellents are also mentioned before.

Suitable further additives are preferably selected from preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide decomposing agents and the like, flame retardants, mould release agents, agents having UV protecting properties, optical brighteners, spreading agents, anti-blocking agents, anti-migrating agents, foam-forming agents, anti-soiling agents, thickeners, further biocides, wetting agents, plasticizers and film forming agents, adhesive or anti-adhesive agents, optical brightening (fluorescent whitening) agents, fragrance, pigments and dyestuffs.

Preferred further additives from the group mentioned above are already mentioned before.

The present invention therefore preferably relates to a process as mentioned above, wherein the aqueous bath comprises as further additives one or more components selected from preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide decomposing agents and the like, flame retardants, mould release agents, agents having UV protecting properties, optical brighteners, spreading agents, anti-blocking agents, anti-migrating agents, foam-forming agents, anti-soiling agents, thickeners, further biocides, wetting agents, plasticizers and film forming agents, adhesive or anti-adhesive agents, optical brightening (fluorescent whitening) agents, fragrance, pigments and dyestuffs.

The insecticide and/or repellent forming part of the aqueous formulation added in step ii) also may be in form of a water-based insecticide and/or repellent concentrate or a solvent, preferably an organic solvent, based insecticide and/or repellent concentrate or a concentrate based on a mixture of water and a solvent, preferably an organic solvent. Water-based concentrates may be in the form of suspensions or dispersions comprising suitable dispersing agents if necessary or in the form of emulsions comprising emulsifiers, solvents and co-solvents it appropriate. Nanoparticular insecticidal formulations may be obtained by dissolving solid solutions of insecticides in a polar organic solvent, e.g. poly vinyl pyrrolidone (PVP). The concentration of the insecticide and/or repellent in the water based or solvent based concentrates is in general between 0.5 to 60%, preferably 1 to 40%, more preferably 3 to 20%.

The particle size of the insecticide and/or repellent in water-based suspensions or dispersions is in general between 50 nm to 20 μm, preferably 50 nm to 8 μm, more preferably 50 nm to 4 μm, most preferably 50 nm to 500 nm.

The aqueous formulation which is added in step ii) comprising at least one insecticide and/or repellent preferably comprises 0.1 to 45% by weight of water, preferably 1 to 25% by weight of water, based on the total of the components in the insecticide except of water.

Step i)

The aqueous bath is contained in a pressure-proof vessel. Suitable pressure-proof vessels are known by a person skilled in the art.

The liquor ratio, which is the weight-rafio between the amount of the textile material or plastics material and the amount of liquid of the aqueous bath, is preferably from 1:3 to 1:50, more preferably from 1:5 to 1:30, most preferably 1:20 (i.e. 1 kg textile material or plastics material in 20 liters of the aqueous bath). In a further preferred embodiment the liquor ratio is from 1:5 to 1:20, preferably from 1:10 to 1:20.

The pH of the aqueous is preferably set slightly acidic, preferably from 3 to 6, more preferably from 4 to 5. Suitable additives for setting the pH to the desired value are known by a person skilled in the art.

Step ii)

The addition of the aqueous formulation comprising at least one insecticide and/or repellent may be carried out by any method known by a person skilled in the art. Suitable aqueous formulations comprising at least one insecticide and/or repellent are mentioned before.

Step iii)

The aqueous bath is heated to a temperature of 100 to 140° C. and the temperature is kept for 20 to 120 minutes. Preferably the queous bath is heated to a temperature of 110 to 130° C., more preferably 120 to 130° C. The temperature of the aqueous bath is preferably kept for 20 to 90 minutes, more preferably for 30 to 60 minutes. The aqueous bath may be heated by any suitable means known by a person skilled in the art.

Step iv)

In step iv) the aqueous bath is cooled and drained. Further, the impregnated textile material or plastics material is rinsed and dryed. Preferably, the aqueous bath is cooled to 90 to 50° C., more preferably to 80 to 60° C. The draining of the bath is carried out by any method known by a person skilled in the art. After the draining the impregnated textile material or plastics material is rinsed, preferably with warm and/or cold water. Finally the impregnated textile material or plastics material obtained is dried by any method known by a person skilled in the art.

The exhaust process for impregnation of a textile material or plastics material of the present invention is therefore preferably carried out as follows:

The textile material or plastics material is placed in an aqueous bath contained in a pressure-proof vessel in a liquor ratio of in general from 1:3 to 1:50, preferably from 1:5 to 1:30, more preferably 1:20 (i.e. 1 kg netting in 20 liters). The pH is set slightly acidic (in general 3-6, preferably 4-5). The aqueous formulation of the insecticide and/or repellent is added preferably as a suspension or emulsion and the bath was heated to in 100 to 140° C., preferably 100 to 130° C., more preferably 120 to 130° C. The temperature was kept for 20-120 minutes, preferably 20 to 90 minutes, more preferably 30 to 60 minutes. Then the treatment liquor is cooled to 90 to 50° C., more preferably to 80 to 60° C. and subsequently the bath is drained. The treated material is rinsed with warm and cold water, respectively and is dried.

In a further embodiment the present invention relates to an impregnated textile material or plastics material obtainable by an exhaust process by comprising the steps
i) placing the textile material or plastics material in an aqueous bath optionally comprising further additives contained in a pressure-proof vessel;
ii) adding an aqueous formulation comprising at least one insecticide and/or repellent;
iii) heating the aqueous bath to a temperature of 100 to 140° C. and keeping the temperature for 20 to 120 minutes; and
iv) cooling and draining the bath, and rinsing and drying the impregnated textile material or plastics material.

Steps i) to iv) of the Impregnation Process are Described in Detail Above.

### EXAMPLES

Binder:

A) Preparation of Polymer Dispersions

General Procedure:

250 g of water and 3 g of a styrene seed (33% by weight) having a medium particle diameter of 30 nm are heated to 85° C. and 5% by weight of feed 2 are added. After 10 min. addition of feed 1 comprising the monomers mentioned below and feed 2 is started.

Feed 2 comprises 3.0 g sodiumperoxidsulfate dissolved in 39.9 g of water. The composition of feed 1 is listed in table 1.

Feed 1 and 2 are added in 3 h, and it was polymerized for further 0.5 h.

TABLE 1
Composition of feed 1 in % by weight pphm (parts per hundred monomers)

| | | | | | | | | | | | | | | BMA- |
|---|---|---|---|---|---|---|---|---|---|---|---|---|---|---|
| Monomer compositions | MMA | S | AN | EHA | BA | EA | HPMA | GMA | MaMol | AMol | AM | AS | FI-1 | Acac |
| A 1 | 27.0 | | | 3.1 | 65.0 | | | | | | 2.0 | 1.0 | 1.9 | |
| A 2 | 23.9 | 5.0 | | 5.3 | 60.0 | | | | | | 1.2 | 0.6 | | 4.0 |
| A 3 | | 16.6 | | 30.0 | 30.0 | 20.0 | | | | 3.0 | | 0.4 | | |
| A 4 | 25.7 | 5.0 | | 5.3 | 60.0 | | | | 3.5 | | | 0.5 | | |
| A 5 | | 14.7 | 11.0 | | 70.0 | | | | 3.5 | | 0.5 | 0.3 | | |
| A 6 | 30.0 | 13.0 | 8.0 | | 45.2 | | | | | 3.0 | 0.5 | 0.3 | | |
| A 7 | 30.0 | 13.0 | 8.0 | | 44.5 | | | | | | 0.5 | 0.3 | | 3.7 |
| A 8 | 33.0 | | | | 60.0 | 3.9 | | | | | 1.0 | 0.5 | 1.6 | |
| A 9 | 20.0 | 20.0 | | 17.0 | 23.0 | 15.3 | | | 3.5 | | | 1.2 | | |
| A 10 | 20.0 | 20.0 | | 17.0 | 23.0 | 15.3 | | | | | 0.4 | 0.3 | | 4.0 |
| A 11 | 10.0 | 10.0 | | | 25.5 | 50.0 | 2.5 | | | | | 2.0 | | |
| A 12 | 10.0 | 10.0 | | | 25.5 | 47.7 | 2.5 | 3.5 | | | 0.7 | 0.1 | | |
| A 13 | | 10.0 | 11.0 | | 60.0 | 14.7 | | 4.0 | | | 0.2 | 0.1 | | |
| A 14 | | 20.0 | 8.0 | | 55.0 | 12.5 | 3.0 | | | | | 1.5 | | |
| A 15 | 26.0 | | 13.0 | | 57.0 | | | | 3.0 | | | 1.0 | | |
| A 16 | 15.0 | | 13.0 | | 68.0 | | | | 3.0 | | | 1.0 | | |
| A 17 | | | 16.0 | | 81.0 | | | | 2.0 | | | 1.0 | | |

The amount of initiator sodium peroxidisulfate is 0.3 parts by weight, the emulsifier comprises 0.4 parts by weight of Dowfax 2A1 (Dow) und 0.6 parts by weight of Lumiten IRA (BASF AG), relating to 100 parts by weight of the monomer composition of table 1.

Abbreviations:
MMA: methyl methacrylate
S: styrene
AN: acrylic nitril
EA: ethyl acrylate
EHA: 2-ethylhexylacrylate
BA: n-butyl acrylate
FI: copolymerizable benzophenone having an acrylic group
GMA: glycidylmethacrylate
BMA-Acac: bitandiolmonoacrylate acetylacetate
Amol: N-methylol acrylamide
MAMol: N-methylol methacrylamide
HPMA: hydroxypropyl methacrylate
AS: acrylic acid
AM: acrylic amide
Dowfax 2A1: 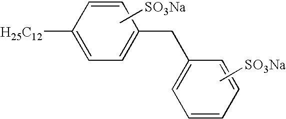
Lumiten IRA:

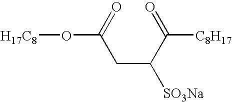

### Examples A1 and A8

Aqueous polymer dispersions comprising Fl-1 polymerizable photo initiator which is later useful as crosslinking agent is a photo initiator of formula 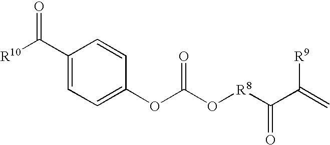
wherein
R⁸ is an organic radical having from 1 to 30 carbon atoms,
R⁹ is H or a methyl group, and
R¹⁰ is a phenyl group which is optionally substituted or a C₁- to C₄-alkyl group.

### Examples of Use (B01 to B14)

The long-lasting insecticidal treatment was performed with aqueous dispersions according to examples A1- A17 on commercially available white polyester netting material (fiber titer 75 denier, 156 mesh, weight 28-32 g/m²) without prior washing. The aqueous treatment baths were prepared by mixing the aqueous dispersions with commercially available emulsions of insecticide and/or repellent, setting pH with buffer solutions and adding a fixative (if needed). The concentrations of the treatment baths were adjusted according to the liquor uptake possible (LU between 60 and 100%). The treatment baths were applied by using a padder-stenter equipment on a laboratory scale (Mathis AG, Switzerland). The netting material is fully immersed into the treatment bath and excess liquor is removed by passing it through cylinders which move in counter-direction. By choosing a defined distance between these cylinders (and thus a defined pressure) the liquor uptake can be controlled. The liquor uptake is measured by weighing an impregnated piece of netting and subtracting the weight of the dry, untreated netting and is given as % weight of liquor on weight of netting. The drying/curing step was performed in a laboratory stenter which allows to control the temperature and time of the treatment.

The treated nettings have been washed different times as mentioned in table 2 (see column “Knock-down 60 min”; the statement in parenthesis (number plus w) indicates how often the netting has been washed before the tesing was carried out). The washing was carried out by the “Montpellier washing procedure” (as described in the annex WHO PVC, Mar. 7, 2002 “Evaluation of wash resistance of long-lasting insecticidal nets”): Net samples are washed individually in beakers containing 0.5 L deionised water and 2 g/L soap (pH 10-11) at 30° C. in a water bath shaken for 10 minutes in clean water at 155 movements per minute. The soap used comprises (among further components like etidronic acid and sodium hydroxide or coconut acid, tetra sodium EDTA and limonene) the following ingredients: Sodium tallowate, water, sodium palm kemelate or sodium cocoate, perfume, glycerol, sodium chloride and some dyestuff (C.I. 77891).

Samples were bioassayed according to the cone testing procedure described below.

Testing Procedure:

The testing follows the basic guidelines of WHO cone testing procedures with a few modifications. Cones (WHO cones (WHOPES 96.1): clear plastic cone structures (11 cm diam.) with a flat flange around the bottom edge and a hole at the apex) are held against treated net pieces (25×25 cm) via a hand-made manifold apparatus modeled similarly to CDC (Centers for Disease Control and Prevention) methodology. The manifold device used is made by cutting four holes (9 cm diameter) in a plastic serving tray (30.5×41.0 cm, Consolidated Plastics). An unmodified tray of the same dimensions acts as a base. Onto the surface of the base tray two pieces of blotter paper are placed, cut to fit inside the tray. A piece of treated netting is then placed onto the blotter paper followed by four WHO cones placed to roughly correspond to the positioning of the holes cut in the manifold (top) tray. This top tray is then placed over the cones so they pass through the holes. The top tray is then securely fastened to the base tray using four large binder clips. The blotter paper helps to ensure a reasonably tight fit of the cones to the netting. Mixed sex mosquitoes, 1-5 days old, are removed from a rearing cage with an aspirator and ca. 5 mosquitoes placed into each cone. A lab timer is started after the introduction of insects into the first cone with each cone supplied with mosquitoes ca. 15 seconds apart, taking one minute to fill all the cones. Each cone is plugged with a rubber stopper immediately after introduction of the insects. Mosquitoes are held in each cone for three minutes where each insect typically rests on the netting surface (if treatment is not strongly repellent). If any mosquito rests on the wall of a cone then the cone can be tapped gently to relocate the insect to the netting. After three minutes, the insects are all removed by aspirator and placed into a plastic holding cup, combining mosquitoes from all four cones, which represent a single replicate. Four replicates of each treatment are recommended. The holding cup consists of a clear plastic cup (9 cm tall×6.5 cm wide) with a plastic screw-on lid. A 1 cm hole in the lid is used to insert the aspirator for insect deposition. One set of mosquitoes from each cone is collected and deposited into the holding container at a time.

Between insertions of the aspirator tip into the container lid, an overhead transparency marker is used to plug the hole to prevent insect escape. After all four cones have been emptied of insects into the holding container, the hole is then plugged with a cotton dental wick soaked with 10% sugar water. The end of the wick sticking out of the cup should have the end manually flattened somewhat to ensure that it doesn't fall into the cup and allow mosquito escape. Knockdown (KD) data are generally taken from the pooled mosquitoes at 60 minutes and 24-hours. A 30-minute (or other) reading can be included if deemed necessary. For speed of knockdown, the mosquito can be left in the cone and the time to KD recorded for each individual mosquito. Each KD mosquito is removed as it goes down to prevent recounting that insect if it once again flies. All mosquitoes are then held as described previously for a 24-hour Mortality count.

TABLE 2
Results

| | Binder | | | | Fixative* | | Insecticide | | | | | Drying/ | | Drying/ | | | | |
|---|---|---|---|---|---|---|---|---|---|---|---|---|---|---|---|---|---|---|
| Exam- | | | | weight | Bath | | Active | Bath | | Weight | Liquor | Curing | | curing | | Knock-down | | Mortality |
| ple | type | Bath conc. | | on net | conc. | | ingredient | conc. | | on net | uptake | temperat. | | time | | 60 min**** | | 24 hrs |
| B 01 | A 17 | 10 | g/L | 1% | 0.5 | g/L | Alpha*** | 6.4 | g/L | 0.64% | 100% | 80° | C. | 3.5 | min | 100% | (20 w) | 100% |
| B 02 | A 17 | 15 | g/L | 1.5% | 0.5 | g/L | Alpha | 6.4 | g/L | 0.64% | 100% | 80° | C. | 3.5 | min | 89.5% | (15 w) | 75.6% |
| B 03 | A 17 | 10 | g/L | 1% | 0.5 | g/L | Alpha | 6.4 | g/L | 0.64% | 100% | 80° | C. | 1 | min | 100% | (15 w) | 98.9% |
| B 04 | A 15 | 10 | g/L | 1% | 0.5 | g/L | Alpha | 6.4 | g/L | 0.64% | 100% | 80° | C. | 3.5 | min | 100% | (15 w) | 96.5% |
| B 04 | A 17 | 10 | g/L | 1% | 0.5 | g/L | Alpha | 6.4 | g/L | 0.64% | 100% | 80° | C. | 2 | min | 100% | (15 w) | 97.8% |
| B 05 | A 17 | 10 | g/l | 1% | 0.5 | g/L | Delta | 3.2 | g/L | 0.32% | 100% | 80° | C. | 3 | min | 98.1% | (15 w) | 100% |
| B 06 | A 15 | 10 | g/L | 1% | 0.4 | g/L | Alpha | 6.4 | g/L | 0.64% | 100% | 100° | C. | 5 | min | 94% | (5 w) | 77% |
| B 07 | A 17 | 10 | g/L | 1% | — | | Alpha | 6.4 | g/L | 0.64% | 100% | 100° | C. | 5 | min | 100% | (5 w) | 78% |
| B 08 | A 17 | 12.5 | g/L | 1% | 0.63 | g/L | Alpha | 8 | g/L | 0.64% | 80% | 80° | C. | 3 | min | 97.8% | (15 w) | 100% |
| B 09 | A 17 | 16.7 | g/L | 1% | 0.83 | g/L | Alpha | 11 | g/L | 0.64% | 60% | 80° | C. | 2 | min | 96.2% | (15 w) | 96.2% |
| B 10 | A 05 | 10 | g/L | 1% | 0.5 | g/L | Alpha | 6.4 | g/L | 0.64% | 100% | 80° | C. | 3.5 | min | 96.9% | (5 w) | 88.8% |
| B 11 | A 08 | 10 | g/L | 1% | 0.5 | g/L | Alpha | 6.4 | g/L | 0.64% | 100% | 80° | C. | 3.5 | min | 100% | (20 w) | 94.3% |
| B 12 | A 15 | 10 | g/L | 1% | 0.6 | g/L** | Alpha | 6.4 | g/L | 0.64% | 100% | 100° | C. | 5 | min | 94.7% | (5 w) | 47.4% |
| B 13 | A 17 | 10 | g/L | 1% | 0.5 | g/L | Alpha | 9.6 | g/L | 0.96% | 100% | 80° | C. | 3.5 | min | 100% | (20 w) | 100% |
| B 14 | A 17 | 10 | g/L | 1% | 0.5 | g/L | Alpha | 16 | g/L | 1.6% | 100% | 80° | C. | 3.5 | min | 100% | (20 w) | 100% |
| B 15 | A 15 | 10 | g/L | 1% | 0.4 | g/L | Alpha | 6.4 | g/L | 0.64% | 100% | 100° | C. | 5 | min | 100% | (5 w) | 77% |
| B 16 | A 15 | 10 | g/L | 1% | 2 | g/L** | Alpha | 6.4 | g/L | 0.64% | 100% | 100° | C. | 5 | min | 94.7% | (5 w) | 47.4% |
| B 17 | A 15 | 30 | g/L | 3% | — | | Alpha | 6.4 | g/L | 0.64% | 100% | 150° | C. | 2 | min | 86.6% | (5 w) | 50.5% |
| B 18 | A 15 | 10 | g/L | 1% | — | | Alpha | 6.4 | g/L | 0.64% | 100% | 150° | C. | 5 | min | 83.7% | (5 w) | 31.6% |
| B 19 | A 15 | 10 | g/L | 1% | — | | Alpha | 6.4 | g/L | 0.64% | 100% | 100° | C. | 2 | min | 94.85% | (5 w) | 53.6% |
| B 20 | A 15 | 30 | g/L | 3% | 1.15 | g/L | Alpha | 6.4 | g/L | 0.64% | 100% | 100° | C. | 2 | min | 89.7% | (5 w) | 29% |

| | | | | | | | | | | | | | | | | | |
|---|---|---|---|---|---|---|---|---|---|---|---|---|---|---|---|---|---|
| B 21 | A 15 | 30 | g/L | 3% | — | Alpha | 6.4 | g/L | 0.64% | 100% | 100° | C. | 5 | min | 96.9% | (5 w) | 61.9% |

| | | | | | | | | | | | | | |
|---|---|---|---|---|---|---|---|---|---|---|---|---|---|
| B 22 | — | — | — | — | — | — | — | — | — | — | 0% | (un- | 1.0% |
| | | | | | | | | | | | | treated) | |

*fixative agent:
isocyanurate based on HMDI which is hydrophilized with a polyethylene oxide and which is dissolved in propylene carbonate (70% by weight of HMDI in 30% by weight of propylene carbonate). The amount of free isocyanate groups is 11 to 12% by weight, based on the amount of isocyanate used as staring material for the preparation of the isocyanurate. The boiling point of the fixative agent is 240-245° C., and the viscosity is 280 mPa · s (Brookfield 100 U/min).
**the fixative agent here is diammonium hydrogen phosphate (calc. 100%)
***Alpha is alpha-Cypermethrin, the insecticide used according to examples B01 to B14, except for example B05, where Deltamethrin was used
****The statement in parentheses (number plus w) indicates how often the netting has been washed before the tesing was carried out

### Example C

5 kg untreated netting material was put into a rotary dryer and 5 Liters of treatment bath, comprising 10 g/L of polymer according to example A17, 6.4 g/L Alphacypermethrin as a dispersion, 0.66 g/L fixative agent (isocyanurate based on HMDI which is hydrophilized with a polyethylene oxide and which is dissolved in propylene carbonate (70% by weight of HMDI in 30% by weight of propylene carbonate);the amount of free isocyanate groups is 11 to 12% by weight, based on the amount of isocyanate used as staring material for the preparation of the isocyanurate;the boiling point of the fixative agent is 240-245° C., and the viscosity is 280 mPa·s (Brookfield 100 U/min) and set to pH 6 with a buffer solution, were sprayed onto the material at room temperature. The dryer was heated to 80° C. while rotating the material and kept at 80° C. for 15 minutes while rotating. The treated netting was washed up to 15 times following the protocol described earlier (“Montpellier washing procedure”) and bioassayed as described above.
Results: Knock-down after 60 minutes: 98.9%
Mortality after 24 hours: 93.5%.

1-33. (canceled)

34. An insecticide or repellent composition for application to a textile material or plastics material which composition comprises a mixture including
a) at least one insecticide and/or at least one repellent as component A, and
b1) at least one acrylic binder as component B1 obtainable by emulsion polymerisation of the following components:
b1a) n-butyl acrylate as component B1A,
b1b) at least one monomer of formula I as component B1B 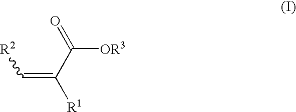
wherein
R¹, R² and are independently selected from C₁- to C₁₀-alkyl which may be linear or branched; substituted or unsubstituted aryl;
R¹ and R² may further be H;
except of R³=n-butyl, when R¹ and R² are H;
b1c) at least one monomer of formula II as component B1C 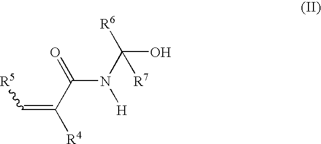
wherein
R⁴, R⁵, R⁶and R⁷ are independently selected from the group consisting of H, C₁- to C₁₀-alkyl which may be linear or branched; substituted or unsubstituted aryl;
b1d) optionally at least one momomer of formula III as component B1D 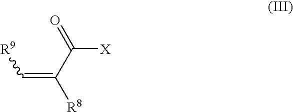
wherein
R⁸ and R⁹ are independently selected from the group consisting of H, C₁- to C₁₀-alkyl which may be linear or branched; substituted or unsubstituted aryl;
X is selected from the group consisting of H, OH, NH₂, OR¹¹OH, glycidyl, hydroxypropyl, 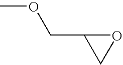
groups of the formula 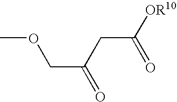
wherein
R¹⁰ is selected from the group consisting of C₁- to C₁₀-alkyl which may be branched or linear; substituted or unsubstituted aryl;
R¹¹ is selected from the group consisting of C₁- to C₁₀-alkylene; substituted or unsubstituted arylenes;
b1e) optionally further monomers which are copolymerizable with the monomers mentioned above selected from
b1e1) polar monomers as component B1E1; and/or
b1e2) non polar monomers as component B1E2.

35. The insecticide or repellent composition as claimed in claim 34, wherein the acrylic binder is obtainable by emulsion polymerization of the following components:
b1a) 10 to 90% by weight, preferably 15 to 80% by weight, more preferably 20 to 70% by weight of component B1A;
b1b) 10 to 90% by weight, preferably 12 to 85% by weight, more preferably 15 to 65% by weight of component B1B;
b1c) 1 to 5% by weight of component B1C;
b1d) 0 to 5% by weight, preferably 1 to 4% by weight, more preferably 0.2 to 3% by weight of component B1D;
b1e) further monomers which are copolymerizable with the monomers mentioned above selected from
b1e1) 0 to 30% by weight, preferably 0 to 25% by weight, more preferably 5 to 20% by weight of component B1E1; and/or
b1e2) 0 to 40% by weight, preferably 0 to 30% by weight, more preferably 5 to 20% by weight of component B1E2;
wherein the sum of the components B1A, B1B, B1C and optionally B1D and B1E is 100% by weight.

36. The insecticide or repellent composition as claimed in claim 34, wherein the acrylic binder is obtainable by emulsion polymerization of the following components:
b1a) 30 to 85% by weight of component B1A;
b1b) 10 to 90% by weight, preferably 12 to 85% by weight, more preferably 15 to 65% by weight of component B1B;
b1c) 1 to 5% by weight of component B1C;
b1d) 0 to 5% by weight, preferably 1 to 4% by weight, more preferably 0.2 to 3% by weight of component B1D;
b1e) further monomers which are copolymerizable with the monomers mentioned above selected from
b1e1) 0 to 30% by weight, preferably 0 to 25% by weight, more preferably 5 to 20% by weight of component B1E1; and/or
b1e2) 0 to 40% by weight, preferably 0 to 30% by weight, more preferably 5 to 20% by weight of component B1E2;
wherein the sum of the components B1A, B1B, B1C and optionally B1D and B1E is 100% by weight.

37. An insecticide or repellent composition for application to a textile material or plastics material which composition comprises a mixture including
a) at least one insecticide and/or repellent as component A, and
b) at least one acrylic binder as component B 1 obtainable by emulsion polymerization of the following components:
b1a) 30 to 85% by weight of n-butylacrylate as component B1A;
b2b) 0 to 65% by weight of at least one monomer of formula I as component B1B 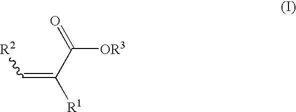
wherein
R¹ is H or methyl, R² is H and R³ is methyl, ethyl, or 2-ethylhexyl, as component B1B, most preferably component B1B is 2-ethylhexylacrylate, methylacrylate, methylmethacrylate or ethylacrylate;
b1c) 1 to 5% by weight of at least one monomer of formula II 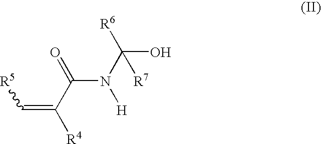
wherein R⁴ is H or methyl, R⁵, R⁶ and R⁷ each are H as component B1C;
b1d) 1 to 10% by weight, preferably 1 to 7% by weight, more preferably 2 to 5% by weight of at least one monomer of formula III 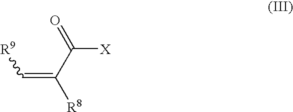
wherein R⁸ and R⁹ are H and X is H, OH, NH₂, OR¹¹OH, glycidyl or a group of the formula 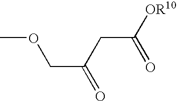
wherein
R¹⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R¹¹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene;
as component B1D, most preferably X is acetoacetyl;
b1e) further monomers which are copolymerizable with the monomers mentioned above selected from
b1e1) 0 to 30% by weight, preferably 0 to 25% by weight, more preferably 5 to 20% by weight of component B1E1, preferably (meth)acrylic nitrile and/or methyl(meth)acrylate;
and/or
b1e2) 0 to 40% by weight, preferably 0 to 30% by weight, more preferably 5 to 20% by weight of component B1E2, preferably styrene and/or a-methylstyrene;
wherein the sum of components B1A, B1B, B1C and optionally B1D and B1E is 100% by weight.

38. An insecticide or repellent composition as claimed in claim 37, wherein component B1 is obtainable by emulsion polymerization of the following components:
b1a) 81.0% by weight of n-butylacrylate as component B1A;
b1c) 2.0% by weight of N-methylol methyacrylamide as component B1C;
bid) 1.0% by weight of acrylic acid as component B1D;
b1e1) 16% by weight of acrylic nitril as component B1E1.

39. The insecticide or repellent composition as claimed in claim 34, wherein the insecticide is selected from
pyrethroid compounds, preferably
Etofenprox: 2-(4-ethoxyphenyl)-2-methylpropyl-3-phenoxybenzyl ether,
Chlorfenapyr: 4-bromo-2-(4-chlorophenyl)-1-ethoxymethyl-5-(trifluoromethyl)-pyrrole-3-carbonitrile,
Fenvalerate: (RS)-alpha-cyano-3-phenoxybenzyl (RS)-2-(4-chlorophenyl)-3 methylbutyrate,
Esfenvalerate: (S)-alpha-cyano-3-phenoxybenzyl (S)-2-(4-chlorophenyl)-3-methylbuty-rate,
Fenpropathrin: (RS)-alpha-cyano-3-phenoxybenzyl 2,2,3,3-tetramethylcyclopropane-carboxylate,
Cypermethrin: (RS)-alpha-cyano-3-phenoxybenzyl (1RS)-cis, trans-3-(2,2-dichlorovinyl)-2,2-dimethylcyclopropanecarboxylate,
alpha-Cypermethrin: racemate comprising the (S)-α-(1R) and (R)-α-(1S) diastereomers,
Permethrin: 3-phenoxybenzyl (1RS)-cis, trans-3-(2,2-dichlorovinyl)-2,2-dimethylcyclopropanecarboxylate,
Cyhalothrin: (RS)-alpha-cyano-3-phenoxybenzyl (Z)-(1RS)-cis-3-(2-chloro-3,3,3-trifluoroprop-1-enyl)-2,2-dimethylcyclopro panecarboxylate, lambda-cyhalothrin,
Deltamethrin: (S)-alpha-cyano-3-phenoxybenzyl (1R)-cis-3-(2,2-dibromovinyl)-2,2-dimethylcyclopropanecarboxylate,
Cycloprothrin: (RS)-alpha-cyano-3-phenoxybenzyl (RS)-2,2-dichloro-1-(4-ethoxyphenyl)cyclopropanecarboxylate,
Fluvalinate: alpha-cyano-3-phenoxybenzyl N-(2-chloro-alpha, alpha, alpha, alpha-trifluoro-p-tolyl)-D-valinate,
Bifenthrin: (2-methylbiphenyl-3-ylmethyl)O(Z)-(1RS)-cis-3-(2-chloro-3,3,3-trifluoro-1-propenyl)-2,2-dimethylcyclopropanecarboxylate,
2-methyl-2-(4-bromodifluoromethoxyphenyl)propyl (3-phenoxybenzyl)ether,
Tralomethrin: (S)-alpha-cyano-3-phenoxybenzyl (1R-cis)3((1′RS)(1′,2′,2′,2′-tetrabromoethyl))-2,2-dimethylcyclopropanecarboxylate,
Silafluofen: 4-ethoxyphenyl(3-(4-fluoro-3-phenoxyphenyl)propyl}dimethylsilane,
D-fenothrin: 3-phenoxybenzyl (1R)-cis, trans)-chrysanthemate,
Cyphenothrin: (RS)-alpha-cyano-3-phenoxybenzyl (1R-cis, trans)-chrysanthemate, D-resmethrin: 5-benzyl-3-furylmethyl (1R-cis, trans)-chrysanthemate,
Acrinathrin: (S)-alpha-cyano-3-phenoxybenzyl (1R-cis(Z))-(2,2-dimethyl-3-(oxo-3-(1,1,1,3,3,3-hexafluoropropyloxy)propenyl(cyclopropanecarboxylate,
Cyfluthrin: (RS)-alpha-cyano-4-fluoro-3-phenoxybenzyl 3-(2,2-dichlorovinyl)-2,2-dimethylcyclopropanecarboxylate,
Tefluthrin: 2,3,5,6-tetrafluoro-4-methylbenzyl (1RS-cis (Z))-3-(2-chloro-3,3,3-trifluoro-prop-1-enyl)-2,2-dimethylcyclopropanecarboxylate,
Transfluthrin: 2,3,5,6-tetrafluorobenzyl (1R-trans)-3-(2,2-dichlorovinyl)-2,2-dimethyl-cyclopropanecarboxylate,
Tetramethrin: 3,4,5,6-tetrahydrophthalimidomethyl (1RS)-cis, trans-chrysanthemate,
Allethrin: (RS)-3-allyl-2-methyl-4-oxocyclopent-2-enyl (1RS)-cis, trans-chrysanthemate,
Prallethrin: (S)-2-methyl-4-oxo-3-(2-propynyl)cyclopent-2-enyl (1R)-cis, trans-chrysanthemate,
Empenthrin: (RS)-1-ethynyl-2-methyl-2-pentenyl (1 R)-cis,trans-chrysanthemate,
Imiprothrin: 2,5-dioxo-3-(prop-2-ynyl)imidazolidin-1-ylmethyl (1R)-cis, trans-2,2-dimethyl-3-(2-methyl-1-propenyl)-cyclopropanecarboxylate,
D-flamethrin: 5-(2-propynyl)-furfuryl (1R)-cis, trans-chrysanthemate, and 5-(2-propynyl)furfuryl 2,2,3,3-tetramethylcyclopropanecarboxylate;
Pyriproxyfen: 4-phenoxyphenyl (RS)-2-(2-pyridyloxy)propyl ether;
pyrethrum;
d-d, trans-cyphenothrin: (RS)-α-cyano-3-phenoxybenzyl (1RS,3RS; 1RS,3SR)-2,2-dimethyl-3-(2-methylprop-1-enyl)cyclopropanecarboxylate;
DDT;
Carbamate compounds, preferably
Alanycarb: S-methyl-N[[N-methyl-N-[N-benzyl-N(2-ethoxy-carbonylethyl)amino-thio]carbamoyl]thioacetimidate,
Bendiocarb: 2,2-dimethyl-1,3-benzodioxol-4-yl-methylcarbamate),
Carbaryl(1-naphthyl N-methylcarbamate,
Isoprocarb: 2-(1-methylethyl)phenyl methylcarbamate,
Carbosulfan: 2,3 dihydro-2,2-dimethyl-7 benzofuranyl[(dibutylamino)thio]methyl-carbamate,
Fenoxycarb: Ethyl[2-(4-phenoxyphenoxy)ethyl]carbamate,
Indoxacarb: Methyl-7-chloro-22,3,4°,5-tetrahydro-2-[methoxycarbonyl (-4-trifluoromethoxyphenyl)]
Propoxur: 2-isopropyloxyphenol methylcarbamate,
Pirimicarb: 2-dimethylamino-5,6-dimethyl-4-pyrimidinyl-dimethylcarbamate,
Thiodiocarb: Dimethyl N,N′(thiobis((methylimino)carbonoyloxy)bisethanimidiothioate);
Methomyl: S-methyl N-((methylcarbamoyl)oxy)thioacetamidate,
Ethiofencarb: 2-((ethylthio)methyl)phenyl methylcarbamate,
Fenothiocarb: S-(4-phenoxybutyl)-N,N-dimethyl thiocarbamate,
Cartap: S,S′-(2-5 dimethylamino)trimethylene)bis (thiocarbamate)hydrochloride,
Fenobucarb: 2-sec-butylphenylmethyl carbamate,
XMC: 3,5-dimethylphenyl-methyl carbamate,
Xylylcarb: 3,4-dimethylphenylmethylcarbamate;
organophosphorous compounds, preferably
Trichlorfon: Phosphoric acid, (2,2,2-trichloro-1-hydroxyethyl)-, dimethyl ester
Fenitrothion: O,O-dimethyl O-(4-nitro-m-tolyl)phosphorothioate,
Diazinon: O,O-diethyl-O-(2-isopropyl-6-methyl-4-pyrimidinyl)phosphorothioate,
Pyridaphenthion: O-(1,6-dihydro-6-oxo-1-phenylpyrazidin-3-yl) O,O-diethyl phosphorothioate,
Pirimiphos-Etyl: O,O-diethyl O-(2-(diethylamino)6-methyl-pyrimidinyl)phosphorothioate, Pirimiphos-Methyl: O-[2-(diethylamino)-6-methyl-4 pyrimidinyl]O,O-dimethyl phosphorothioate,
Etrimphos: O-6-ethoxy-2-ethyl-pyrimidin-4-yl-O,O-dimethyl-phosphorothioate,
Fenthion: O,O-dimethyl-O-[-3-methyl-4-(methylthio)phenyl phosphorothioate,
Phoxim: 2-(diethoxyphosphinothoyloxyimino)-2-phenylacetonitrile,
Chlorpyrifos: O,O-diethyl-O-(3,5,6-trichloro-2-pyrinyl)phosphorothioate,
Chlorpyriphosmethyl: O,O-dimethyl O-(3,5,6-trichloro-2-pyridinyl)phosphor-othioate,
Cyanophos: O,O-dimethyl O-(4 cyanophenyl)phosphorothioate,
Pyraclofos: (R,S) [4-chlorophenyl)-pyrazol-4-yl]-O-ethyl-S-n-propyl phosphorothioate,
Acephate: O,S-dimethyl acetylphosphoroamidothioate,
Azamethiphos: S-(6-chloro-2,3-dihydro-oxo-1,3-oxazolo[4,5-b]pyridine-3-ylmethyl phosphorothioate,
Malathion: O,O-dimethyl phosphorodithioate ester of diethyl mercaptosuccinate,
Temephos: (O,O′(thiodi-4-1-phenylene) O,O,O,O-tetramethyl phosphorodithioate,
Dimethoate: ((O,O-dimethyl S-(n-methylcarbamoylethyl)phosphorodithioate,
Formothion: S[2-formylmethylamino]-2-oxoethyl]-O,O-dimethyl phosphorodithioate,
Phenthoate: O,O-dimethyl S-(alpha-ethoxycarbonylbenzal)-phosphorodithioate;
Iodofenphos: O-(2,5-dichloro-4-iodophenyl)-O,O-dimethyl-phosphorthioate;
Insecticides with a sterilising effect on adult mosquitoes, preferably
1-(alfa-(chloro-alpha-cyclopropylbenzylidenamino -oxy)-p-tolyl)-3-(2,6-difluorobenzoyl)urea,
Diflubenzuron: N-(((3,5-dichloro-4-(1,1,2,2-tetraflouroethoxy)phenylamino)carbonyl)2,6 difluoro benzamid,
Triflumuron: 2-Chloro-N-(((4-(trifluoromethoxy)phenyl)-amino-)carbonyl)benz-amide, or a triazin, preferably N-cyclopropyl-1,3,5-triazine-2,4,6-triamin; and
Lambda-cyhalothrine:
α-cyano-3-phenoxybenzyl-3-(2-chloro-3,3,3-trifluoroprop-1-enyl)-2,2-dimethylcyclopropane carboxylate, as a 1:1 mixture of(Z)-(1R,3R), R-ester and (Z)-(1S,3S), S-ester;
the repellent is selected from N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control, preferably {(+/−)-3-allyl-2-methyl-4-oxocyclopent-2-(+)-enyl-(+)-trans-chrysantemate (Esbiothrin), a repellent derived from or identical with plant extracts, preferably limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella), IR3535 (ethyl butylacetylaminopropionate), icaridin (1-piperidinecarboxylic acid 2-(2-hydroxyethyl)-1-methylpropylester);
niclosamide as suitable mulloscicide;
suitable rodenticides of first generation anticoagulant rodenticides and second generation anticoagulant rodenticides selected from the group consisting of warfarin, chlorphacinone, coumatetralyl as first generation anticoagulant rodenticides, and flocoumafen, brodifacoum, difenacoum, bromadialone, difethialone, and bromethalin as second generation anticoagulant rodenticides;
antifungal agents as fungicides used in the case of athlete's foot selected from the group consisting of clotrimazole: 1-(2-chlorotrityl)imidazole, miconazole: 1-[2-(2,4-dichlorophenyl)-2-[(2,4-dichlorophenyl)methoxy]ethyl]-1H-imidazole, econazole 4-[2-[(4-chlorophenyl)methoxy]-2-(2,4-dichlorophenyl)-ethyl]-4H-imidazole, tioconazole:1-[2-[(2-chloro-3-thienyl)methoxy]-2-(2,4-dichlorophenyl)-ethyl]-1H-imidazole, undecylenic acid, terbinafine hydrochloride: N,6,6-trimethyl-N-(naphthalen-4-ylmethyl)hept-2-en-4-yn-1-amine hydrochloride (lamisil topical), and tolnaftate: N-methyl-N-(m-tolyl)-1-naphthalen-3-yloxy-thioformamide;
further fungicides, preferably
Azoles, preferably selected from Bitertanol, Bromoconazol, Cyproconazol, Difenoconazole, Dinitroconazol, Epoxiconazol, Fenbuconazol, Fluquiconazol, Flusilazol, Flutriafol, Hexaconazol, Imazalil, Ipconazol, Metconazol, Myclobutanil, Penconazol, Propiconazol, Prochloraz, Prothioconazol, Simeconazol, Tebuconazol Tetraconazol, Triadimefon, Triadimenol, Triflumizol, and Triticonazol;
Strobilurines, preferably selected from Azoxystrobin, Dimoxystrobin, Fluoxastrobin, Kresoxim-methyl, Metominostrobin Orysastrobin, Picoxystrobin, Pyraclostrobin, and Trifloxystrobin;
Acylalanines, preferably selected from Benalaxyl, Metalaxyl, Mefenoxam, Ofurace, and Oxadixyl;
Aminderivatives, preferably selected from Aldimorph, Do dine, Dodemorph, Fenpropimorph, Fenpropidin, Guazatine, Iminoctadine, Spiroxamin, and Tridemorph;
Anilinopyrimidines, preferably selected from Pyrimethanil, Mepanipyrim, and Cyprodinil;
Dicarboximides, preferably selected from Iprodion, Myclozolin, Procymidon, and Vinclozolin;
Cinnamic acid amide and analoges, preferably selected from Dimethomorph, Flumetover, and Flumorph;
Antibiotics, preferably selected from Cycloheximid, Griseofulvin, Kasugamycin, Natamycin, Polyoxin, and Streptomycin;
Dithiocarbamates, preferably selected from Ferbam, Nabam, Maneb, Mancozeb, Metam, Metiram, Propineb, Polycarbamat, Thiram, Ziram and Zineb;
Heterocyclic compounds, preferably selected from Anilazin, Benomyl, Boscalid, Carbendazim, Carboxin, Oxycarboxin, Cyazofamid, Dazomet, Dithianon, Famoxadon, Fenamidon, Fenarimol, Fuberidazol, Flutolanil, Furametpyr, Isoprothiolan, Mepronil, Nuarimol, Picobenzamid, Probenazol, Proquinazid, Pyrifenox, Pyroquilon, Quinoxyfen, Silthiofam, Thiabendazol, Thifluzamid, Thiophanat-methyl, Tiadinil, Tricyclazol, and Triforine M inorganics;
Nitrophenylderivatives, preferably selected from Binapacryl, Dinocap, Dinobuton, Nitrophthal-isopropyl;
Phenylpyrrole Fenpiclonil, and Fludioxonil;
Sulfonic acid derivatives, preferably selected from Captafol, Captan, Dichlofluanid, Folpet, and Tolylfluanid;
Further fungicides, preferably selected from Acibenzolar-S-methyl, Benthiavalicarb, Carpropamid, Chlorothalonil, Cyflufenamid, Cymoxanil, Dazomet, Diclomezin, Diclocymet, Diclofluanid, Diethofencarb, Edifenphos, Ethaboxam, Fenhexamid, Fentin-Acetat, Fenoxanil, Ferimzone, Fluazinam, Fosetyl, Fosetyl-Aluminium, Phosphorige Säure, Iprovalicarb, Hexachlorbenzol, Metrafenon, Pencycuron, Propamocarb, Phthalid, Toloclofosmethyl, Quintozene, and Zoxamid.

40. The insecticide or repellent composition as claimed in claim 34, wherein the particle size of the insecticide and/or repellent is from 50 nm to 20 μm, preferably 50 nm to 8 μm, more preferably 50 nm to 4 μm, most preferably 50 nm to 500 nm.

41. The insecticide or repellent composition as claimed in claim 34, further comprising one or more component selected from water, preservatives, detergents, stabilizers, agents having UV-protecting properties, optical brighteners, spreading agents, anti-migrating agents, foam-forming agents, wetting agents, anti-soiling agents, thickeners, further biozides, plasticizers, adhesive agents, fragrance, pigments and dyestuffs.

42. The insecticide or repellent composition as claimed in claim 34, comprising from about 0.001 to 95% by weight ofthe insecticide and/or repellent.

43. The insecticide or repellent composition as claimed in claim 34, which is provided as a kit for impregnation by the end-user or in a local factory.

44. The insecticide or repellent composition as claimed in claim 43 wherein the composition in the kit is adapted for preparing a solution or emulsion by adding water.

45. An impregnated textile material or plastics material for insect killing and/or repellence of an insect comprising
a) at least one insecticide and/or at least one repellent, and
b1) at least one acrylic binder as claimed in claim 34.

46. The impregnated textile material or plastics material as claimed in claim 45 further comprising at least one insecticide and at least one repellent.

47. The impregnated textile material or plastics material as claimed in claim 45 further comprising one or more components selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, fragrance, pigments and dyestuffs.

48. The impregnated textile material or plastics material as claimed in claim 45 comprising from 0.001 to 10% by weight of the weight of the textile material or plastics material of at least one insecticide and/or at least one repellent.

49. The impregnated textile material or plastics material as claimed in claim 48, comprising
a) 0.01 to 10% by weight, preferably 0.05 to 7% by weight of the weight of the textile material or plastics material of at least one insecticide and/or at least one repellent, more preferably 0.1 to 6% by weight of the weight of the textile material or plastics material of a pyrethroid as at least one insecticide and/or at least one repellent, and
b1) 0.001 to 10% by weight, preferably 0.1 to 5% by weight, more preferably 0.2 to 3% by weight of the weight of the textile material or plastics material of at least one acrylic binder wherein the at least one acrylic binder is a component B1 obtainable by emulsion polymerisation of the following components:
b1a) n-butyl acrylate as component B1A,
b1b) at least one monomer of formula I as component B1B 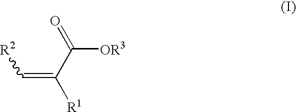
wherein
R¹, R² and are independently selected from C₁- to C₁₀-alkyl which may be linear or branched; substituted or unsubstituted aryl;
R¹ and R² may further be H;
except of R³=n-butyl, when R¹ and R² are H;
b1c) at least one monomer of formula II as component B1C 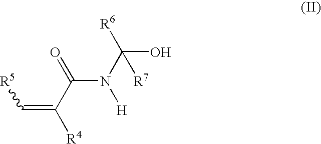
wherein
R⁴, R⁵, R⁶and R⁷ are independently selected from the group consisting of H, C₁- to C₁₀-alkyl which may be linear or branched; substituted or unsubstituted aryl;
b1d) optionally at least one momomer of formula III as component B1D 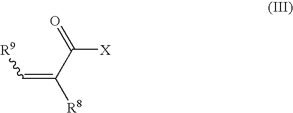
wherein
R⁸ and R⁹ are independently selected from the group consisting of H, C₁- to C₁₀-alkyl which may be linear or branched; substituted or unsubstituted aryl;
X is selected from the group consisting of H, OH, NH₂, OR¹¹OH, glycidyl, hydroxypropyl, 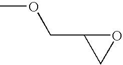
groups of the formula 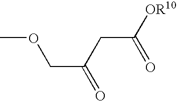
wherein
R¹⁰ is selected from the group consisting of C₁- to C₁₀-alkyl which may be branched or linear; substituted or unsubstituted aryl;
R¹¹ is selected from the group consisting of C₁- to C₁₀-alkylene; substituted or unsubstituted arylenes;
b1e) optionally further monomers which are copolymerizable with the monomers mentioned above selected from
b1e1) polar monomers as component B1E1;
and/or
b1e2) non polar monomers as component B1E2.

50. A process for impregnation of a textile material or plastics material comprising the steps
i) forming an aqueous formulation or a melt, comprising at least one insecticide and/or at least one repellent as defined in claim 39 and at least one acrylic binder
ii) applying the aqueous formulation to the textile material or plastics material by
iia) passing the textile material or plastics material through the aqueous formulation;
or
iib) bringing the textile material or plastics material in contact with a roller that is partly or fully dipped into the aqueous formulation and drawing the aqueous formulation to the side of the textile material or plastics material in contact with the roller;
or
iic) double-side coating of the textile material or plastics material;
or
iid) spraying the aqueous formulation onto the textile material or plastics material; wherein the spraying is carried out with any suitable device for spraying by hand or automatically, for example with an aerosol can or devices usually used in a factory;
or
iie) applying the aqueous formulation in form of a foam;
or
iif) submerging the textile material or plastics material into the aqueous formulation;
or
iig) brushing the aqueous formulation onto or into the textile material or plastics material;
or
iih) pouring the aqueous formulation onto the textile material or plastics material;
or
applying the melt by calandering or with a doctor-blade;
iii) optionally removing surplus aqueous formulation or surplus melt; and
iv) drying and/or curing the textile material or plastics material; wherein the at least one acrylic binder is component B1 obtainable by emulsion polymerisation of the following components:
b1a) n-butyl acrylate as component B1A,
b1b) at least one monomer of formula I as component B1B 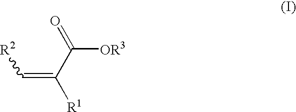
wherein
R¹, R² and are independently selected from C₁- to C₁₀-alkyl which may be linear or branched; substituted or unsubstituted aryl;
R¹ and R² may further be H;
except of R³=n-butyl, when R¹ and R² are H;
b1c) at least one monomer of formula II as component B1C 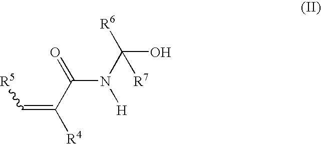
wherein
R⁴, R⁵, R⁶and R⁷ are independently selected from the group consisting of H, C₁- to C₁₀-alkyl which may be linear or branched; substituted or unsubstituted aryl;
b1d) optionally at least one momomer of formula III as component B1D 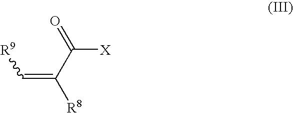
wherein
R⁸ and R⁹ are independently selected from the group consisting of H, C₁- to C₁₀-alkyl which may be linear or branched; substituted or unsubstituted aryl;
X is selected from the group consisting of H, OH, NH₂, OR¹¹OH, glycidyl, hydroxypropyl, 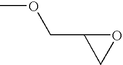
groups of the formula 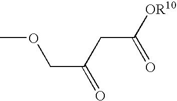
wherein
R¹⁰ is selected from the group consisting of C₁- to C₁₀-alkyl which may be branched or linear; substituted or unsubstituted aryl;
R¹¹ is selected from the group consisting of C₁- to C₁₀-alkylene; substituted or unsubstituted arylenes;
b1e) optionally further monomers which are copolymerizable with the monomers mentioned above selected from
b1e1) polar monomers as component B1E1; and/or
b1e2) non polar monomers as component B1E2.

51. The process as claimed in claim 50, wherein step iia) is carried out by completely submerging the textile material or plastics material in the aqueous formulation either in a trough containing the aqueous formulation or passing the textile material or plastics material through the aqueous formulation which is held between two horizontally oriented rollers.

52. The process as claimed in claim 50, wherein the insecticide and/or repellent is an insecticide and/or repellent as defined in claim 39.

53. The process as claimed in claim 50, wherein the aqueous formulation further comprises one or more ingredients selected from the group consisting of detergents, stabilizers, agents having UV-protecting properties, optical brighteners, spreading agents, anti-migrating agents, preservatives, foam-forming agents, wetting agents, thickeners, further biozides, plasticizers, adhesive agents, anti-soiling agents, fragrance, pigments and dyestuffs.

54. The process as claimed in claim 50, wherein the dying of the textile material or plastics material is carried out simultaneously with the impregnation of the textile material or plastics material, wherein an aqueous formulation is formed further comprising at least one dyestuff and/or at least one pigment.

55. A process for coating a textile material or plastics material by applying a composition comprising at least one insecticide and/or at least one repellent and at least one acrylic binder as defined in claim 34 to the textile material or plastics material.

56. The process as claimed in claim 55, wherein the composition further comprises one or more ingredients selected from the group consisting of detergents, stabilizers, agents having UV-protecting properties, optical brighteners, spreading agents, anti-migrating agents, preservatives, foam-forming agents, anti-soiling agents, wetting agents, thickeners, further biozides, plasticizers, adhesive agents, fragrance, pigments and dyestuffs.

57. The impregnated textile material or plastics material as claimed in claim 45, wherein the textile material or plastics material is a netting made from polyester, especially polyethylene terephthalate.

58. The insecticide or repellent composition as claimed in claim 34, additionally comprising a fixative agent.

59. The insecticide or repellent composition as claimed in claim 58, wherein the fixative agent is an isocyanurate comprising free isocyanate groups, preferably an isocyanurate based on alkylene diisocyanates having from 4 to 12 carbon atoms in the alkylene unit, like 1,12-dodecane diisocyanate, 2-ethyltetramethylene diisocyanate-1,4,2-methylpentamethylene diisocyanate-1,5, tetramethylene diisocyanate-1,4, lysinester diisocyanate (LDI), hexamethylene diisocyanate-1,6 (HMDI), cyclohexane-1,3-and/or-1,4-diisocyanate, 2,4-and 2,6-hexahydro-toluylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluylene diisocyanate, 4,4′-,2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before, more preferably the isocyanurates are based on hexamethylene diisocyanate-1,6 (HMDI);
wherein the isocyanurate is in a preferred embodiment hydrophilized with a polyalkylene oxide based on ethylene oxide and/or 1,2-propylene oxide, preferably polyethylene oxide.

60. The insecticide or repellent composition as claimed in claim 59, wherein the fixative agent is an isocyanurate based on HMDI which is hydrophilized with a polyethylene oxide and which is dissolved in propylene carbonate (70% by weight of HMDI in 30% by weight of propylene carbonate), wherein the amount of free isocyanate groups is 11 to 12% by weight, based on the amount of isocyanate used as staring material for the preparation of the isocyanurate.

61. The insecticide or repellent composition as claimed in claim 58 comprising the following components, based on the solids content of the composition:
a) 20 to 70% by weight, preferably 25 to 65% by weight, more preferably 30 to 65% by weight of at least one insecticide and/or at least one repellent (component A), and
b1) 29 to 72% by weight, preferably 34 to 70% by weight, more preferably 33 to 66 by weight of at least one acrylic binder (component B1) as defined above, comprising;
b1a) 10 to 90% by weight, preferably 15 to 80% by weight, more preferably 20 to 70% by weight based on the acrylic binder of n-butyl acrylate (component B1A);
b1b) 10 to 90% by weight, preferably 12 to 85% by weight, more preferably 15 to 65% by weight based on the acrylic binder of at least one monomer of formula I (component B1B);
b1c) 1 to 5% by weight based on the acrylic binder of at least one monomer of formula II (component B1C);
b1d) 0 to 5% by weight, preferably 1 to 4% by weight, more preferably 0.2 to 3% by weight based on the acrylic binder of at least one monomer of formula III (component B1D);
b1e) further monomers which are copolymerizable with the monomers mentioned (component B1E) above selected from
b1e1) 0 to 30% by weight, preferably 0 to 25% by weight, more preferably 5 to 20% by weight based on the acrylic binder of at least one polar momomer, preferably (meth)acrylic nitrile and/or methyl(meth)acrylate (component B1E1); and/or
b1e2) 0 to 40% by weight, preferably 0 to 30% by weight, more preferably 5 to 20% by weight based on the acrylic binder of at least one non polar momomer, preferably styrene and/or a-methylstyrene (component B1E1);
c) 1 to 8% by weight, preferably 1 to 5% by weight, more preferably 2 to 4% by weight of at least one fixative agent (component C);
wherein the sum of the components is 100% by weight of solids content of the insecticide composition.

62. The process as claimed in claim 50, wherein the curing in step iv) is carried out at 60 to 170° C.

63. The insecticide and/or repellent composition as claimed in claim 38, wherein the textile material or plastics material is a polyester netting material.

64. The insecticide and/or repellent composition as claimed in claim 38, wherein the component A is alpha-Cypermethrin.

65. The insecticide and/or repellent composition as claimed in claim 38 comprising:
a) 6.4 g/L to 16 g/L of alpha-Cypermethrin as component A,
b1) 10 g/L to 16.7 g/L of an acrylic binder as claimed in claim 5 as component B1,
c) 0 g/L to 0.83 g/L, preferably 0.5 g/L to 0.83 g/L of a fixative agent which is an isocyanurate based on HMDI which is hydrophilized with a polyethylene oxide and which is dissolved in propylene carbonate (70% by weight of HMDI in 30% by weight of propylene carbonate), wherein the amount of free isocyanate groups is 11 to 12% by weight, based on the amount of isocyanate used as staring material for the preparation of the isocyanurate, as component C,
and
water.

66. An impregnated polyester netting material comprising
a) 0.32 to 1.6% by weight of the weight of the polyester netting material of alpha-Cypermethrin as component A,
b1) 1 to 1.5% weight of the weight of the polyester netting material of an acrylic binder as claimed in claim 5 as component B1.

67. The insecticide or repellent composition as claimed in claim 37, wherein the insecticide is selected from
pyrethroid compounds, preferably
Etofenprox: 2-(4-ethoxyphenyl)-2-methylpropyl-3-phenoxybenzyl ether,
Chlorfenapyr: 4-bromo-2-(4-chlorophenyl)-1-ethoxymethyl-5-(trifluoromethyl)-pyrrole-3-carbonitrile,
Fenvalerate: (RS)-alpha-cyano-3-phenoxybenzyl (RS)-2-(4-chlorophenyl)-3 methylbutyrate,
Esfenvalerate: (S)-alpha-cyano-3-phenoxybenzyl (S)-2-(4-chlorophenyl)-3-methylbuty-rate,
Fenpropathrin: (RS)-alpha-cyano-3-phenoxybenzyl 2,2,3,3-tetramethylcyclopropane-carboxylate,
Cypermethrin: (RS)-alpha-cyano-3-phenoxybenzyl (1RS)-cis, trans-3-(2,2-dichlorovinyl)-2,2-dimethylcyclopropanecarboxylate,
alpha-Cypermethrin: racemate comprising the (S)-α-(1R) and (R)-α-(1S) diastereomers,
Permethrin: 3-phenoxybenzyl (1RS)-cis, trans-3-(2,2-dichlorovinyl)-2,2-dimethylcyclopropanecarboxylate,
Cyhalothrin: (RS)-alpha-cyano-3-phenoxybenzyl (Z)-(1RS)-cis-3-(2-chloro-3,3,3-trifluoroprop-1-enyl)-2,2-dimethylcyclopro panecarboxylate, lambda-cyhalothrin,
Deltamethrin: (S)-alpha-cyano-3-phenoxybenzyl (1R)-cis-3-(2,2-dibromovinyl)-2,2-dimethylcyclopropanecarboxylate,
Cycloprothrin: (RS)-alpha-cyano-3-phenoxybenzyl (RS)-2,2-dichloro-1-(4-ethoxyphenyl)cyclopropanecarboxylate,
Fluvalinate: alpha-cyano-3-phenoxybenzyl N-(2-chloro-alpha, alpha, alpha, alpha-trifluoro-p-tolyl)-D-valinate,
Bifenthrin: (2-methylbiphenyl-3-ylmethyl)O(Z)-(1RS)-cis-3-(2-chloro-3,3,3-trifluoro-1-propenyl)-2,2-dimethylcyclopropanecarboxylate,
2-methyl-2-(4-bromodifluoromethoxyphenyl)propyl (3-phenoxybenzyl)ether,
Tralomethrin: (S)-alpha-cyano-3-phenoxybenzyl (1R-cis)3((1′RS)(1′,2′,2′,2′-tetrabromoethyl))-2,2-dimethylcyclopropanecarboxylate,
Silafluofen: 4-ethoxyphenyl(3-(4-fluoro-3-phenoxyphenyl)propyl}dimethylsilane, D-fenothrin: 3-phenoxybenzyl (1R)-cis, trans)-chrysanthemate,
Cyphenothrin: (RS)-alpha-cyano-3-phenoxybenzyl (1R-cis, trans)-chrysanthemate, D-resmethrin: 5-benzyl-3-furylmethyl (1R-cis, trans)-chrysanthemate,
Acrinathrin: (S)-alpha-cyano-3-phenoxybenzyl (1R-cis(Z))-(2,2-dimethyl-3-(oxo-3-(1,1,1,3,3,3-hexafluoropropyloxy)propenyl(cyclopropanecarboxylate,
Cyfluthrin: (RS)-alpha-cyano-4-fluoro-3-phenoxybenzyl 3-(2,2-dichlorovinyl)-2,2-dimethylcyclopropanecarboxylate,
Tefluthrin: 2,3,5,6-tetrafluoro-4-methylbenzyl (1RS-cis (Z))-3-(2-chloro-3,3,3-trifluoro-prop-1-enyl)-2,2-dimethylcyclopropanecarboxylate,
Transfluthrin: 2,3,5,6-tetrafluorobenzyl (1R-trans)-3-(2,2-dichlorovinyl)-2,2-dimethyl-cyclopropanecarboxylate,
Tetramethrin: 3,4,5,6-tetrahydrophthalimidomethyl (1RS)-cis, trans-chrysanthemate,
Allethrin: (RS)-3-allyl-2-methyl-4-oxocyclopent-2-enyl (1RS)-cis, trans-chrysanthemate,
Prallethrin: (S)-2-methyl-4-oxo-3-(2-propynyl)cyclopent-2-enyl (1R)-cis, trans-chrysanthemate,
Empenthrin: (RS)-1-ethynyl-2-methyl-2-pentenyl (1R)-cis,trans-chrysanthemate,
Imiprothrin: 2,5-dioxo-3-(prop-2-ynyl)imidazolidin-1-ylmethyl (1R)-cis, trans-2,2-dimethyl-3-(2-methyl-1-propenyl)-cyclopropanecarboxylate,
D-flamethrin: 5-(2-propynyl)-furfuryl (1R)-cis, trans-chrysanthemate, and 5-(2-propynyl)furfuryl 2,2,3,3-tetramethylcyclopropanecarboxylate;
Pyriproxyfen: 4-phenoxyphenyl (RS)-2-(2-pyridyloxy)propyl ether;
pyrethrum;
d-d, trans-cyphenothrin: (RS)-α-cyano-3-phenoxybenzyl (1RS,3RS;1RS,3SR)-2,2-dimethyl-3-(2-methylprop-1-enyl)cyclopropanecarboxylate;
DDT;
Carbamate compounds, preferably
Alanycarb: S-methyl-N[[N-methyl-N-[N-benzyl-N(2-ethoxy-carbonylethyl)amino-thio]carbamoyl]thioacetimidate,
Bendiocarb: 2,2-dimethyl-1,3-benzodioxol-4-yl-methylcarbamate),
Carbaryl(1-naphthyl N-methylcarbamate,
Isoprocarb: 2-(1-methylethyl)phenyl methylcarbamate,
Carbosulfan: 2,3 dihydro-2,2-dimethyl-7-benzofuranyl[(dibutylamino)thio]methyl-carbamate,
Fenoxycarb: Ethyl[2-(4-phenoxyphenoxy)ethyl]carbamate,
Indoxacarb: Methyl-7-chloro-22,3,4°,5-tetrahydro-2-[methoxycarbonyl (-4-trifluoromethoxyphenyl)]
Propoxur: 2-isopropyloxyphenol methylcarbamate,
Pirimicarb: 2-dimethylamino-5,6-dimethyl-4-pyrimidinyl-dimethylcarbamate,
Thiodiocarb: Dimethyl
N,N′(thiobis((methylimino)carbonoyloxy)bisethanimidiothioate);
Methomyl: S-methyl N-((methylcarbamoyl)oxy)thioacetamidate,
Ethiofencarb: 2-((ethylthio)methyl)phenyl methylcarbamate,
Fenothiocarb: S-(4-phenoxybutyl)-N,N-dimethyl thiocarbamate,
Cartap: S,S′-(2-5 dimethylamino)trimethylene)bis (thiocarbamate)hydrochloride,
Fenobucarb: 2-sec-butylphenylmethyl carbamate,
XMC: 3,5-dimethylphenyl-methyl carbamate,
Xylylcarb: 3,4-dimethylphenylmethylcarbamate;
organophosphorous compounds, preferably
Trichlorfon: Phosphoric acid, (2,2,2-trichloro-1-hydroxyethyl)-, dimethyl ester
Fenitrothion: O,O-dimethyl O-(4-nitro-m-tolyl)phosphorothioate,
Diazinon: O,O-diethyl-O-(2-isopropyl-6-methyl-4-pyrimidinyl)phosphorothioate,
Pyridaphenthion: O-(1,6-dihydro-6-oxo-1-phenylpyrazidin-3-yl) O,O-diethyl phosphorothioate,
Pirimiphos-Etyl: O,O-diethyl O-(2-(diethylamino)6-methyl-pyrimidinyl)phosphorothioate, Pirimiphos-Methyl: O-[2-(diethylamino)-6-methyl-4 pyrimidinyl]O,O-dimethyl phosphorothioate,
Etrimphos: O-6-ethoxy-2-ethyl-pyrimidin-4-yl-O,O-dimethyl-phosphorothioate,
Fenthion: O,O-dimethyl-O-[-3-methyl-4-(methylthio)phenyl phosphorothioate,
Phoxim: 2-(diethoxyphosphinothoyloxyimino)-2-phenylacetonitrile,
Chlorpyrifos: O,O-diethyl-O-(3,5,6-trichloro-2-pyrinyl)phosphorothioate,
Chlorpyriphosmethyl: O,O-dimethyl O-(3,5,6-trichloro-2-pyridinyl)phosphorothioate,
Cyanophos: O,O-dimethyl O-(4 cyanophenyl)phosphorothioate,
Pyraclofos: (R,S) [4-chlorophenyl)-pyrazol-4-yl]-O-ethyl-S-n-propyl phosphorothioate,
Acephate: O,S-dimethyl acetylphosphoroamidothioate,
Azamethiphos: S-(6-chloro-2,3-dihydro-oxo-1,3-oxazolo [4,5-b]pyridine-3-ylmethyl phosphorothioate,
Malathion: O,O-dimethyl phosphorodithioate ester of diethyl mercaptosuccinate,
Temephos: (O,O′(thiodi-4-1-phenylene) O,O,O,O-tetramethyl phosphorodithioate,
Dimethoate: ((O,O-dimethyl S-(n-methylcarbamoylethyl)phosphorodithioate,
Formothion: S[2-formylmethylamino]-2-oxoethyl]-O,O-dimethylphosphorodithioate,
Phenthoate: O,O-dimethyl S-(alpha-ethoxycarbonylbenzal)-phosphorodithioate;
Iodofenphos: O-(2,5-dichloro-4-iodophenyl)-O,O-dimethyl-phosphorthioate;
Insecticides with a sterilising effect on adult mosquitoes, preferably
1-(alfa-(chloro-alpha-cyclopropylbenzylidenamino-oxy)-p-tolyl)-3-(2,6-difluorobenzoyl)urea,
Diflubenzuron: N-(((3,5-dichloro-4-(1,1,2,2-tetraflouroethoxy)phenylamino)carbonyl)2,6 difluoro benzamid,
Triflumuron: 2-Chloro-N-(((4-(trifluoromethoxy)phenyl)-amino-)carbonyl)benz-amide, or a triazin, preferably N-cyclopropyl-1,3,5-triazine-2,4,6-triamin; and
Lambda-cyhalothrine:
α-cyano-3-phenoxybenzyl-3-(2-chloro-3,3,3-trifluoroprop-1-enyl)-2,2-dimethylcyclopropane carboxylate, as a 1:1 mixture of(Z)-(1R,3R), R-ester and (Z)-(1S,3S), S-ester;
the repellent is selected from N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control, preferably {(+/−)-3-allyl-2-methyl-4-oxocyclopent-2-(+)-enyl-(+)-trans-chrysantemate (Esbiothrin), a repellent derived from or identical with plant extracts, preferably limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella), IR3535 (ethyl butylacetylaminopropionate), icaridin (1-piperidinecarboxylic acid 2-(2-hydroxyethyl)-1-methylpropylester);
niclosamide as suitable mulloscicide;
suitable rodenticides of first generation anticoagulant rodenticides and second generation anticoagulant rodenticides selected from the group consisting of warfarin, chlorphacinone, coumatetralyl as first generation anticoagulant rodenticides, and flocoumafen, brodifacoum, difenacoum, bromadialone, difethialone, and bromethalin as second generation anticoagulant rodenticides;
antifungal agents as fungicides used in the case of athlete's foot selected from the group consisting of clotrimazole: 1-(2-chlorotrityl)imidazole, miconazole: 1-[2-(2,4-dichlorophenyl)-2-[(2,4-dichlorophenyl)methoxy]ethyl]-1H-imidazole, econazole 4-[2-[(4-chlorophenyl)methoxy]-2-(2,4-dichlorophenyl)-ethyl]-4H-imidazole, tioconazole:1-[2-[(2-chloro-3-thienyl)methoxy]-2-(2,4-dichlorophenyl)-ethyl]-1H-imidazole, undecylenic acid, terbinafine hydrochloride: N,6,6-trimethyl-N-(naphthalen-4-ylmethyl)hept-2-en-4-yn-1-amine hydrochloride (lamisil topical), and tolnaftate: N-methyl-N-(m-tolyl)-1-naphthalen-3-yloxy-thioformamide;
further fungicides, preferably
Azoles, preferably selected from Bitertanol, Bromoconazol, Cyproconazol, Difenoconazole, Dinitroconazol, Epoxiconazol, Fenbuconazol, Fluquiconazol, Flusilazol, Flutriafol, Hexaconazol, Imazalil, Ipconazol, Metconazol, Myclobutanil, Penconazol, Propiconazol, Prochloraz, Prothioconazol, Simeconazol, Tebuconazol Tetraconazol, Triadimefon, Triadimenol, Triflumizol, and Triticonazol;
Strobilurines, preferably selected from Azoxystrobin, Dimoxystrobin, Fluoxastrobin, Kresoxim-methyl, Metominostrobin Orysastrobin, Picoxystrobin, Pyraclostrobin, and Trifloxystrobin;
Acylalanines, preferably selected from Benalaxyl, Metalaxyl, Mefenoxam, Ofurace, and Oxadixyl;
Aminderivatives, preferably selected from Aldimorph, Do dine, Dodemorph, Fenpropimorph, Fenpropidin, Guazatine, Iminoctadine, Spiroxamin, and Tridemorph;
Anilinopyrimidines, preferably selected from Pyrimethanil, Mepanipyrim, and Cyprodinil;
Dicarboximides, preferably selected from Iprodion, Myclozolin, Procymidon, and Vinclozolin;
Cinnamic acid amide and analoges, preferably selected from Dimethomorph, Flumetover, and Flumorph;
Antibiotics, preferably selected from Cycloheximid, Griseofulvin, Kasugamycin, Natamycin, Polyoxin, and Streptomycin;
Dithiocarbamates, preferably selected from Ferbam, Nabam, Maneb, Mancozeb, Metam, Metiram, Propineb, Polycarbamat, Thiram, Ziram and Zineb;
Heterocyclic compounds, preferably selected from Anilazin, Benomyl, Boscalid, Carbendazim, Carboxin, Oxycarboxin, Cyazofamid, Dazomet, Dithianon, Famoxadon, Fenamidon, Fenarimol, Fuberidazol, Flutolanil, Furametpyr, Isoprothiolan, Mepronil, Nuarimol, Picobenzamid, Probenazol, Proquinazid, Pyrifenox, Pyroquilon, Quinoxyfen, Silthiofam, Thiabendazol, Thifluzamid, Thiophanat-methyl, Tiadinil, Tricyclazol, and Triforine M inorganics;
Nitrophenylderivatives, preferably selected from Binapacryl, Dinocap, Dinobuton, Nitrophthal-isopropyl;
Phenylpyrrole Fenpiclonil, and Fludioxonil;
Sulfonic acid derivatives, preferably selected from Captafol, Captan, Dichlofluanid, Folpet, and Tolylfluanid;
Further fungicides, preferably selected from Acibenzolar-S-methyl, Benthiavalicarb, Carpropamid, Chlorothalonil, Cyflufenamid, Cymoxanil, Dazomet, Diclomezin, Diclocymet, Diclofluanid, Diethofencarb, Edifenphos, Ethaboxam, Fenhexamid, Fentin-Acetat, Fenoxanil, Ferimzone, Fluazinam, Fosetyl, Fosetyl-Aluminium, Phosphorige Säure, Iprovalicarb, Hexachlorbenzol, Metrafenon, Pencycuron, Propamocarb, Phthalid, Toloclofos-methyl, Quintozene, and Zoxamid.

68. The insecticide or repellent composition as claimed in claim 37, which is provided as a kit for impregnation by the end-user or in a local factory.

69. An impregnated textile material or plastics material for insect killing and/or repellence of an insect comprising
a) at least one insecticide and/or at least one repellent, and
b1) at least one acrylic binder as claimed in claim 37.

70. A process for impregnation of a textile material or plastics material comprising the steps
i) forming an aqueous formulation or a melt, comprising at least one insecticide and/or at least one repellent as defined in claim 39 and at least one acrylic binder and optionally further ingredients;
ii) applying the aqueous formulation to the textile material or plastics material by
iia) passing the textile material or plastics material through the aqueous formulation;
or
iib) bringing the textile material or plastics material in contact with a roller that is partly or fully dipped into the aqueous formulation and drawing the aqueous formulation to the side of the textile material or plastics material in contact with the roller;
or iic) double-side coating of the textile material or plastics material;
or
iid) spraying the aqueous formulation onto the textile material or plastics material; wherein the spraying is carried out with any suitable device for spraying by hand or automatically, for example with an aerosol can or devices usually used in a factory;
or
iie) applying the aqueous formulation in form of a foam;
or iif) submerging the textile material or plastics material into the aqueous formulation;
or
iig) brushing the aqueous formulation onto or into the textile material or plastics material;
or
iih) pouring the aqueous formulation onto the textile material or
or
applying the melt by calandering or with a doctor-blade;
iii) optionally removing surplus aqueous formulation or surplus melt; and
iv) drying and/or curing the textile material or plastics material;
wherein the at least one acrylic binder is a component B1 obtainable by emulsion polymerisation of the following components:
b1a) n-butyl acrylate as component B1A,
b1b) at least one monomer of formula I as component B1B 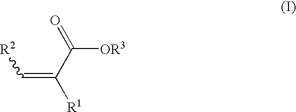
wherein
R¹, R² and are independently selected from C₁- to C₁₀-alkyl which may be linear or branched; substituted or unsubstituted aryl;
R¹ and R² may further be H;
except of R³=n-butyl, when R¹ and R² are H;
b1c) at least one monomer of formula II as component B1C 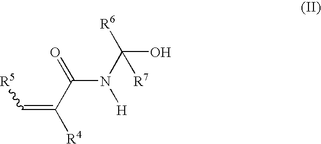
wherein
R⁴, R⁵, R⁶and R⁷ are independently selected from the group consisting of H, C₁- to C₁₀-alkyl which may be linear or branched; substituted or unsubstituted aryl;
b1d) optionally at least one momomer of formula III as component B1D 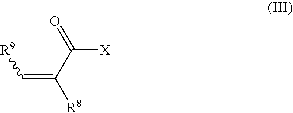
wherein
R⁸ and R⁹ are independently selected from the group consisting of H, C₁- to C₁₀-alkyl which may be linear or branched; substituted or unsubstituted aryl;
X is selected from the group consisting of H, OH, NH₂, OR¹¹OH, glycidyl, hydroxypropyl, 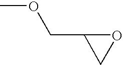
groups of the formula 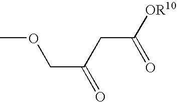
wherein
R¹⁰ is selected from the group consisting of C₁- to C₁₀-alkyl which may be branched or linear; substituted or unsubstituted aryl;
R¹¹ is selected from the group consisting of C₁- to C₁₀-alkylene; substituted or unsubstituted arylenes;
b1e) optionally further monomers which are copolymerizable with the monomers mentioned above selected from
b1e1) polar monomers as component B1E1; and/or
b1e2) non polar monomers as component B1E2.

71. A process for coating a textile material or plastics material by applying a composition comprising at least one insecticide and/or at least one repellent and at least one acrylic binder as defined in claim 37 to the textile material or plastics material.

72. The impregnated textile material or plastics material as claimed in claim 71, wherein the textile material or plastics material is a netting made from polyester, especially polyethylene terephthalate.

73. The insecticide or repellent composition as claimed in claim 37, additionally comprising a fixative agent.
